(19) United States
(12) Patent Application Publication
(10) Pub. No.: US 2020/0301378 A1
(43) Pub. Date: Sep. 24, 2020

(54) DEDUCING FLOOR PLANS USING MODULAR WALL UNITS

(71) Applicant: Apple Inc., Cupertino, CA (US)

(72) Inventors: Travis McQueen, San Jose, CA (US); Clark Della Silva, San Francisco, CA (US); Scott G. Johnston, Los Gatos, CA (US); Wade Barnett, San Jose, CA (US); Christopher Merrill, San Francisco, CA (US); Jay C. Couch, San Martin, CA (US)

(73) Assignee: Apple Inc., Cupertino, CA (US)

(21) Appl. No.: 16/362,501

(22) Filed: Mar. 22, 2019

(51) Int. Cl. G05B 15/02

(52) U.S. Cl. CPC G05B 15/02; H01H 2300/03; G05B 2219/2642

(57) ABSTRACT

In some embodiments, a method comprises receiving floor plan data corresponding to at least one of a location, dimensions, or orientation of one or more walls defining at least one room of a building; receiving sensor data corresponding to detected activity within the at least one room of the building; determining a type of the at least one room of the building based on the detected activity; and modifying the floor plan data to include the determined type of the at least one of the one or more rooms, wherein a visual representation of the floor plan data is operable to be output on a display device. The method can further include determining an area of the at least one room of the building, where determining the type of the at least one room can be further based on the area of the at least one room.

### TECHNICAL FIELD

The present disclosure relates generally to electrical systems and in particular to a modular and configurable utility system for a building.

### BACKGROUND

Smart home technology has greatly improved in power and functionality in recent years and can provide an enhanced user experience that can be tailored to meet an individual user's particular needs. For instance, smart lights, smart security systems, smart entertainment systems, environmental control systems (HVAC), and the like, are becoming more and more customizable and integrated as the internet-of-things (IoT) sets a foothold in modern home designs.

Configuring the smart home can present many challenges. For instance, the differentiation of brands and their incompatibilities between each other, differing connection and communication protocols, wiring and connector types, hardware/software configurations, and general system set up can be daunting to the average consumer. Even technology savvy enthusiasts may be challenged by the non-intuitive and often frustratingly laborious process of configuring a fully integrated smart home. Furthermore, smart home networks often need to be reconfigured, sometimes extensively, as old equipment is replaced with new equipment. Despite the many advantages that smart home technology brings to society, there is a need for smart home systems that can allow lay-consumers to more easily customize, scale, and reconfigure their homes in a more effortless and user friendly manner.

### SUMMARY

In certain embodiments, a method may include receiving floor plan data corresponding to at least one of a location, dimensions, or orientation of one or more walls defining at least one room of a building; receiving sensor data corresponding to detected activity within the at least one room of the building; determining a type of the at least one room of the building based on the detected activity; and modifying the floor plan data to include the determined type of the at least one of the one or more rooms, wherein a visual representation of the floor plan data is operable to be output on a display device. The method may further include determining an area of the at least one room of the building, where determining the type of the at least one room is further based on the area of the at least one room. In some aspects, the floor plan data can include a plurality of rooms, and wherein determining the type of the at least one room is further based on the location of the one room relative to locations of the remaining plurality of rooms.

In some embodiments, the sensor data can include image data, and the method can further comprise: tracking a movement of an object in the one or more rooms, wherein determining the type of the at least one of the one or more rooms is further based on at least one of: an amount of time the object has spent in the one or more rooms, the amount of time based on the tracked movement of the object; and a traffic pattern of the object in the one or more rooms, the traffic pattern of the object based on the tracked movement of the object. In some cases, the sensor data may include audio data, and the method can further comprise: tracking a movement of an object in the one or more rooms, where determining the type of the at least one of the one or more rooms is further based on at least one of: an amount of time the object has spent in the one or more rooms, the amount of time based on the tracked movement of the object; and a traffic pattern of the object in the one or more rooms, the traffic pattern of the object based on the tracked movement of the object.

In certain embodiments, the sensor data may include electromagnetic interference (EMI) data, and the method can further comprise: determining a type of the object based on the EMI data; tracking a movement of an object in the one or more rooms, wherein determining the type of the at least one of the one or more rooms is further based on at least one of: an amount of time the object has spent in the one or more rooms, the amount of time based on the tracked movement of the object; and a traffic pattern of the object in the one or more rooms, the traffic pattern of the object based on the tracked movement of the object. In some cases, determining a type of the object based on the EMI data includes determining a unique digital identifier (unique ID) of the object. In some aspects, the digital floor plan data can include a location of a powered appliance within the at least one room of the building, where the sensor data includes power data from the powered appliance, and where determining the type of the at least one room of the building is further based on the power data of the powered appliance. The power data may include (but is not limited to) at least one of: a power usage profile; a power frequency profile; a power factor; and inductive or reactive loads. In some aspects, the digital floor plan data may include a location of a host unit disposed within one of the one or more walls, where the sensor data includes accelerometer data from the host unit, the accelerometer data including data corresponding to vibrations within the wall that the host unit is disposed in, and where the determining the type of the at least one room of the building is further based on characteristics and a location of the detected vibrations.

Certain embodiments may include a non-transitory computer-program product tangibly embodied in a machine-readable non-transitory storage medium that includes instructions configured to cause one or more processors to perform operations including: receiving floor plan data corresponding to at least one of a location, dimensions, or orientation of one or more walls defining at least one room of a building; receiving sensor data corresponding to detected activity within the at least one room of the building; determining a type of the at least one room of the building based on the detected activity; and modifying the floor plan data to include the determined type of the at least one of the one or more rooms, wherein a visual representation of the floor plan data is operable to be output on a display device. The instructions may be further configured to cause the one or more processors to perform operations including: determining an area of the at least one room of the building, where determining the type of the at least one room is further based on the area of the at least one room. The floor plan data can include a plurality of rooms, and determining the type of the at least one room can be further based on the location of the one room relative to locations of the remaining plurality of rooms.

In further embodiments, the sensor data can include image data, and the instructions can be further configured to cause the one or more processors to perform operations including: tracking a movement of an object in the one or more rooms, where determining the type of the at least one of the one or more rooms is further based on at least one of: an amount of time the object has spent in the one or more rooms, the amount of time based on the tracked movement of the object; and a traffic pattern of the object in the one or more rooms, the traffic pattern of the object based on the tracked movement of the object. In some cases, the sensor data can include audio data, and wherein the instructions are further configured to cause the one or more processors to perform operations including: tracking a movement of an object in the one or more rooms, where determining the type of the at least one of the one or more rooms is further based on at least one of: an amount of time the object has spent in the one or more rooms, the amount of time based on the tracked movement of the object; and a traffic pattern of the object in the one or more rooms, the traffic pattern of the object based on the tracked movement of the object.

In certain embodiments, a system comprises: one or more processors; and one or more non-transitory, electronic storage mediums that include instructions configured to cause the one or more processors to: receive floor plan data corresponding to at least one of a location, dimensions, or orientation of one or more walls defining at least one room of a building; receive sensor data corresponding to detected activity within the at least one room of the building; determine a type of the at least one room of the building based on the detected activity; and modify the floor plan data to include the determined type of the at least one of the one or more rooms, wherein a visual representation of the floor plan data is operable to be output on a display device. In some implementations, the instructions can be further configured to cause the one or more processors to: determine an area of the at least one room of the building, where determining the type of the at least one room is further based on the area of the at least one room. In some cases, the floor plan data may include a plurality of rooms, and determining the type of the at least one room can be further based on the location of the one room relative to locations of the remaining plurality of rooms.

In some embodiments, the sensor data can include image data, and the instructions can be further configured to cause the one or more processors to: track a movement of an object in the one or more rooms, where determining the type of the at least one of the one or more rooms is further based on at least one of: an amount of time the object has spent in the one or more rooms, the amount of time based on the tracked movement of the object; and a traffic pattern of the object in the one or more rooms, the traffic pattern of the object based on the tracked movement of the object. Alternatively or additionally, the sensor data can include audio data, wherein the instructions are further configured to cause the one or more processors to: track a movement of an object in the one or more rooms, where determining the type of the at least one of the one or more rooms is further based on at least one of: an amount of time the object has spent in the one or more rooms, the amount of time based on the tracked movement of the object; and a traffic pattern of the object in the one or more rooms, the traffic pattern of the object based on the tracked movement of the object.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION

Aspects, features and advantages of embodiments of the present disclosure will become apparent from the following description of embodiments in reference to the appended drawings.

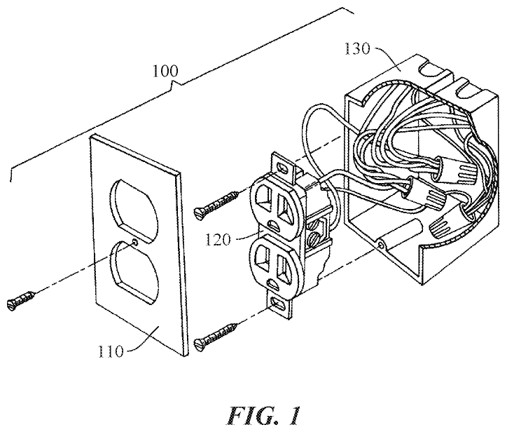

FIG. 1 shows a simplified diagram of a conventional power outlet in a residential, commercial, or industrial environment.

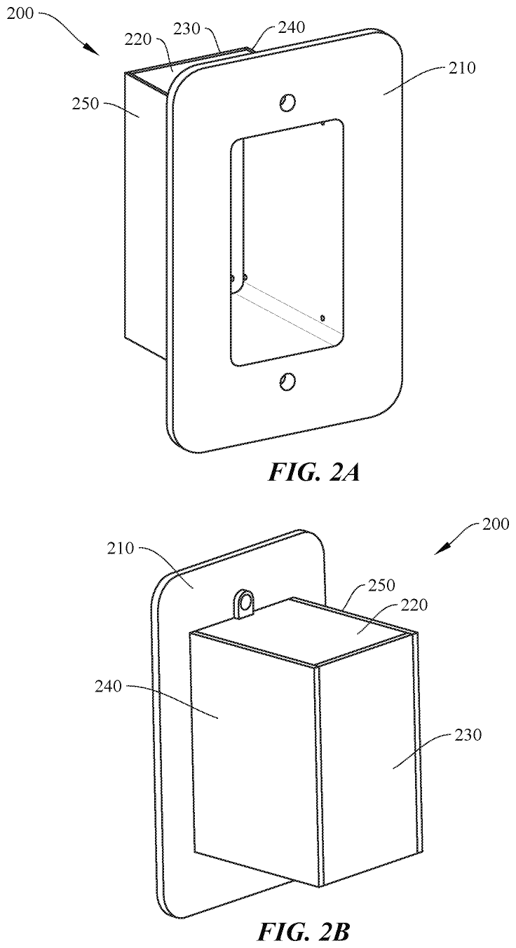

FIG. 2A shows a simplified diagram of a wall-mounted host unit, according to certain embodiments.

FIG. 2B shows a rear view of a simplified diagram of a wall-mounted host unit, according to certain embodiments.

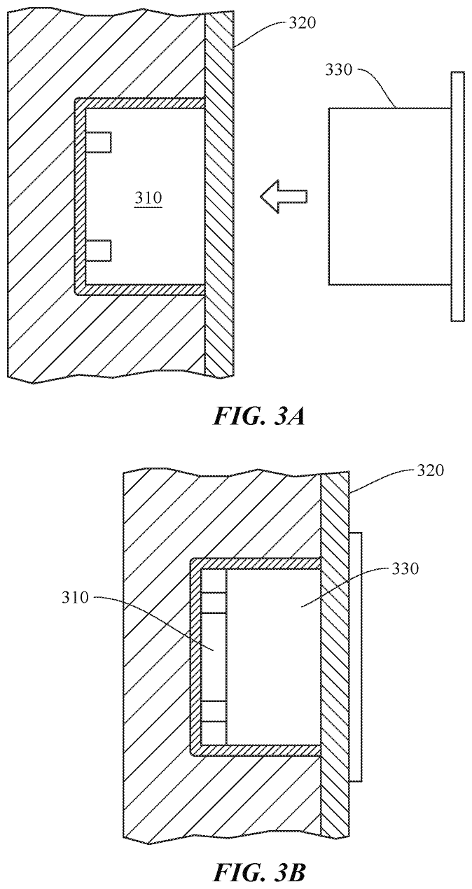

FIG. 3A shows how a modular accessory can be coupled to a wall-mounted host unit, according to certain embodiments.

FIG. 3B shows how a modular accessory can be coupled to a wall-mounted host unit, according to certain embodiments.

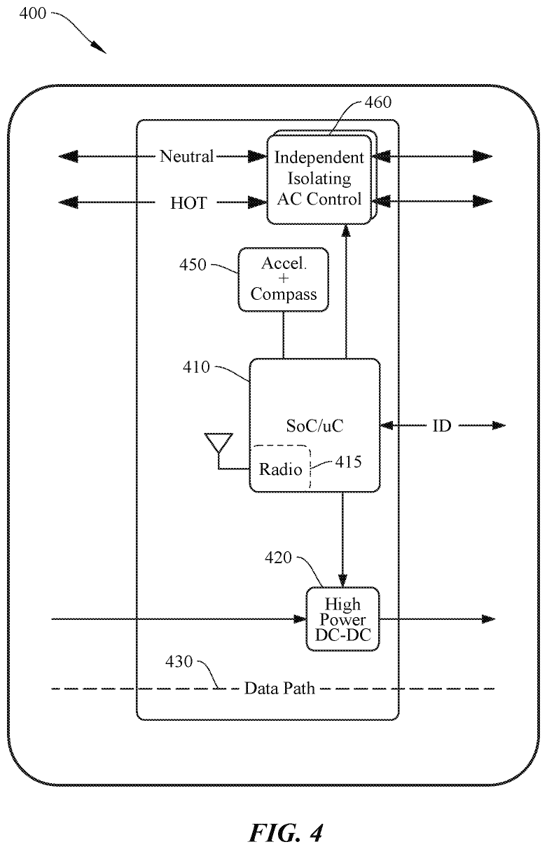

FIG. 4 shows a simplified block diagram of a system for operating a host unit, according to certain embodiments.

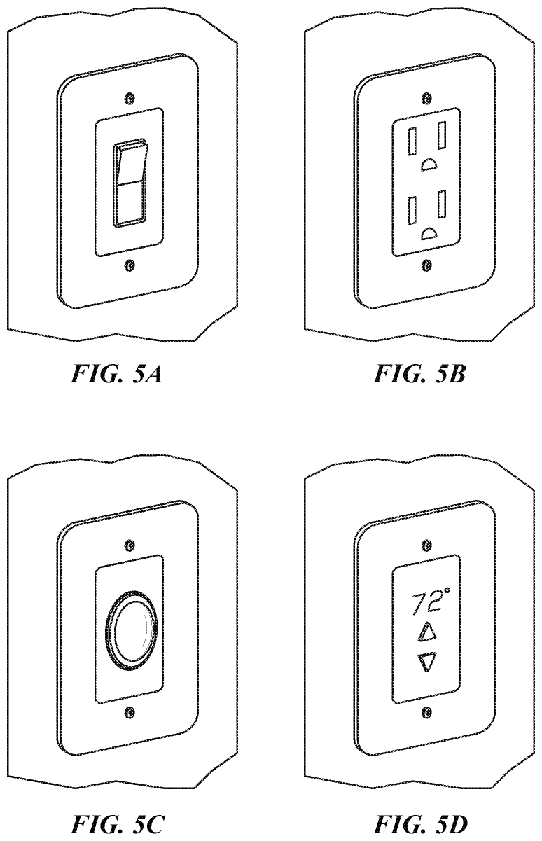

FIG. 5A shows a simplified diagram of a typical modular accessory, according to certain embodiments.

FIG. 5B shows a simplified diagram of a typical modular accessory, according to certain embodiments.

FIG. 5C shows a simplified diagram of a typical modular accessory, according to certain embodiments.

FIG. 5D shows a simplified diagram of a typical modular accessory, according to certain embodiments.

FIG. 5E shows a simplified diagram of multiple modular accessories integrated with a single host unit, according to certain embodiments.

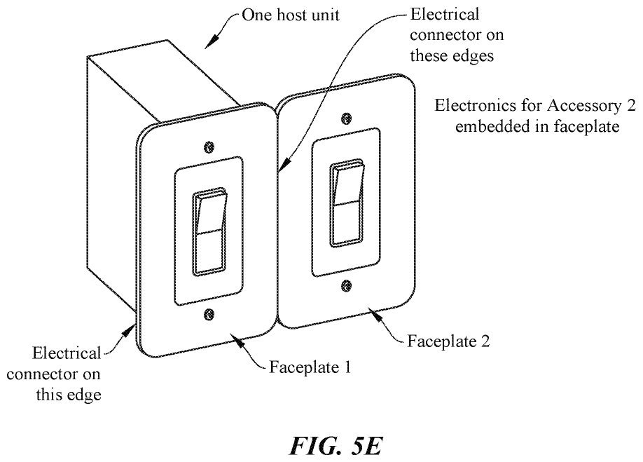

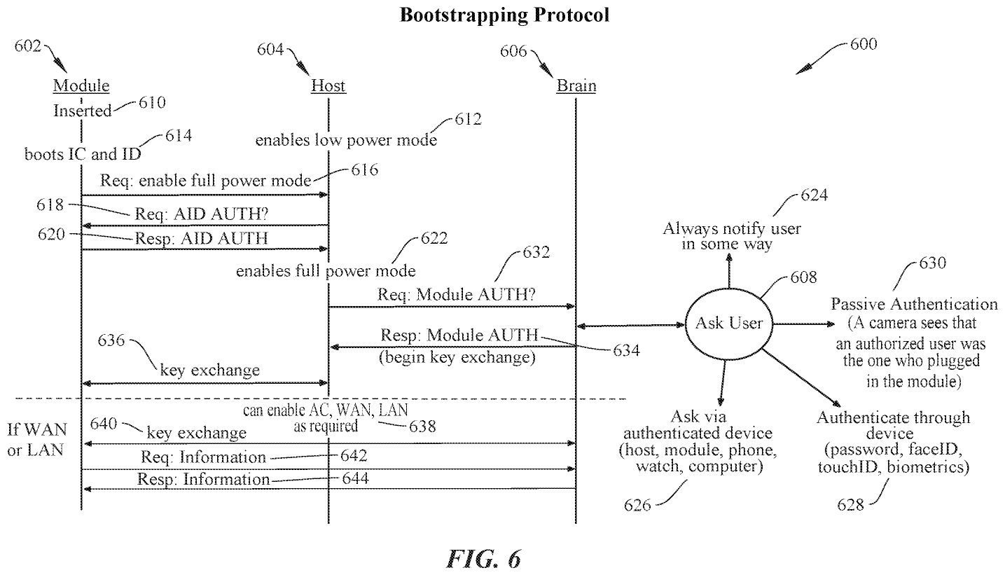

FIG. 6 shows a sequence chart showing an operation of a bootstrapping protocol for modular accessories, according to certain embodiments.

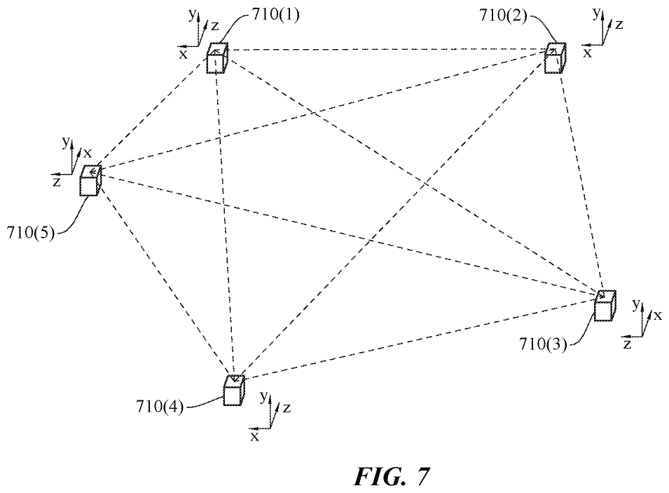

FIG. 7 shows a simplified diagram of a number of host units in communication with one another in a configurable home infrastructure, according to certain embodiments.

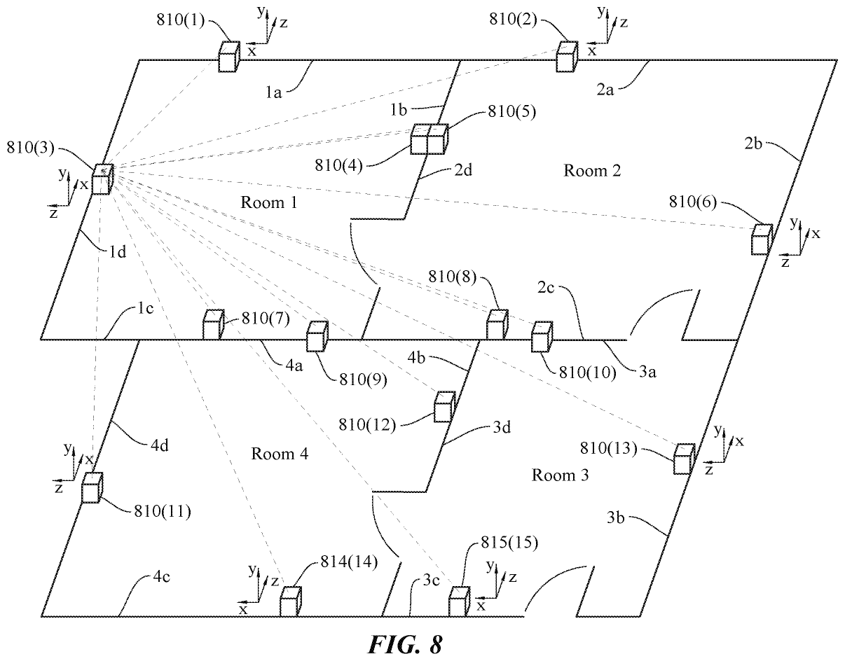

FIG. 8 shows a simplified diagram showing an automatically generated floor plan for a home, according to certain embodiments.

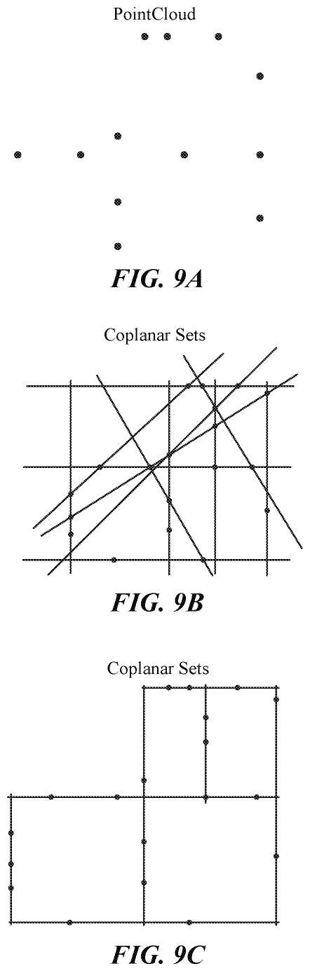

FIGS. 9A-9C show various stages of determining a floor plan for a building, according to certain embodiments.

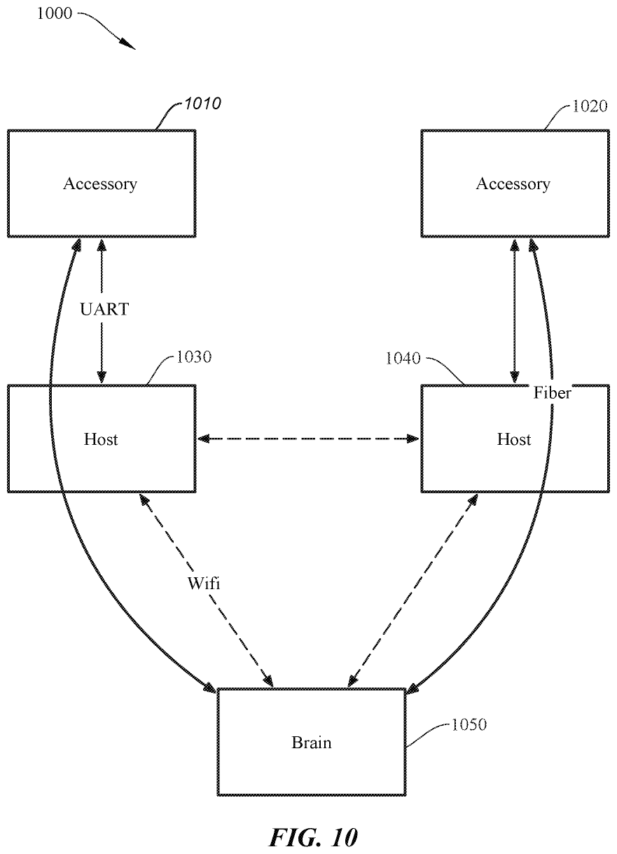

FIG. 10 shows a typical configuration of a plurality of a modular accessories, host units, and a brain, according to certain embodiments.

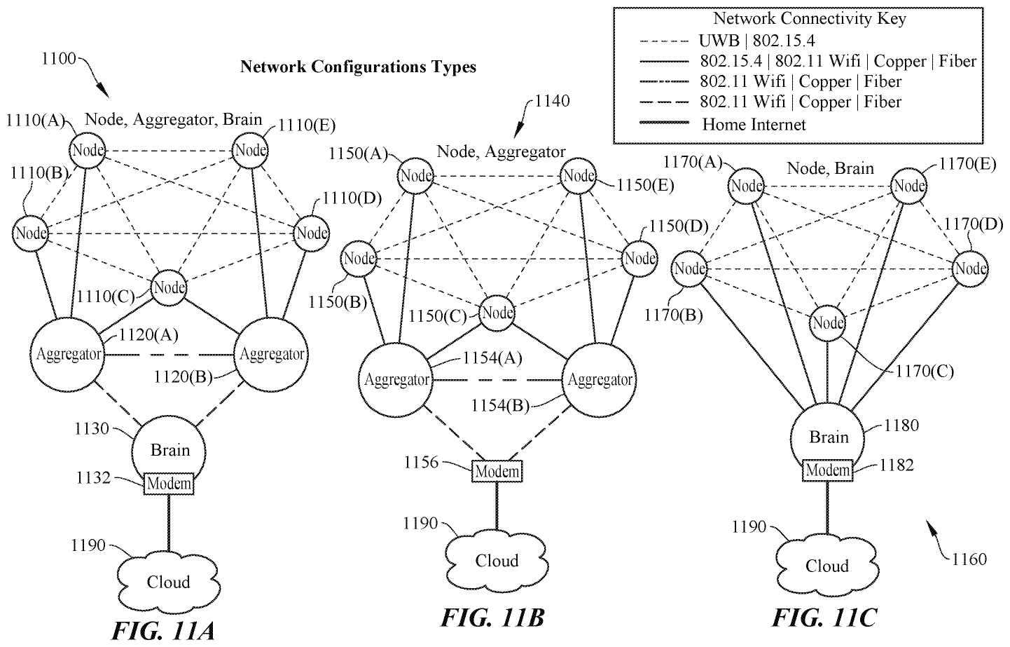

FIGS. 11A-11C show a number of possible node, aggregator, brain network configurations, according to certain embodiments.

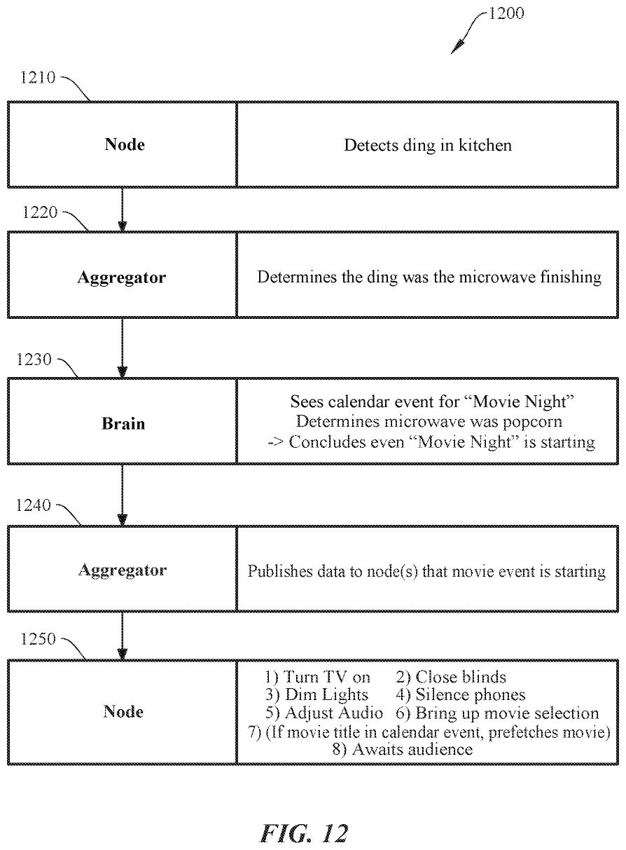

FIG. 12 shows a simplified flow chart of a typical node, aggregator, brain interaction, according to certain embodiments.

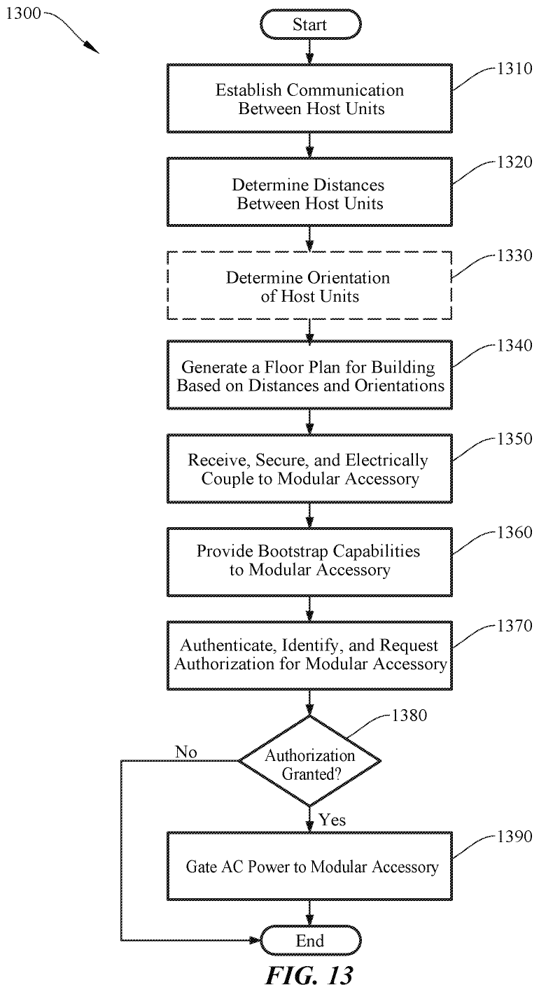

FIG. 13 shows a simplified flow chart for automatically generating a floor plan and provisioning a modular accessory, according to certain embodiments.

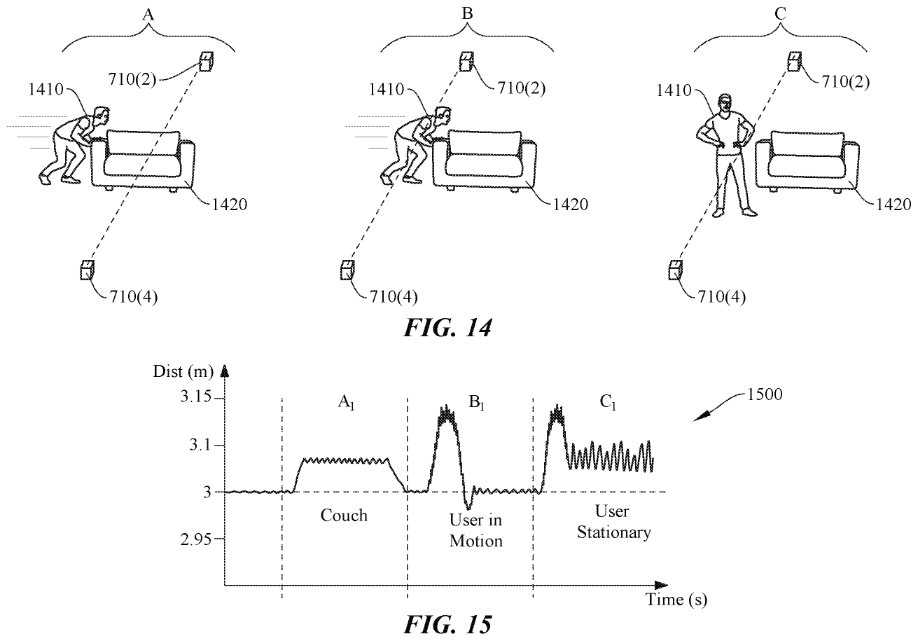

FIG. 14 shows aspects of object detection using a configurable home infrastructure, according to certain embodiments.

FIG. 15 is a simplified graph showing changes is distance measurements between host units as different objects are passed between them, according to certain embodiments.

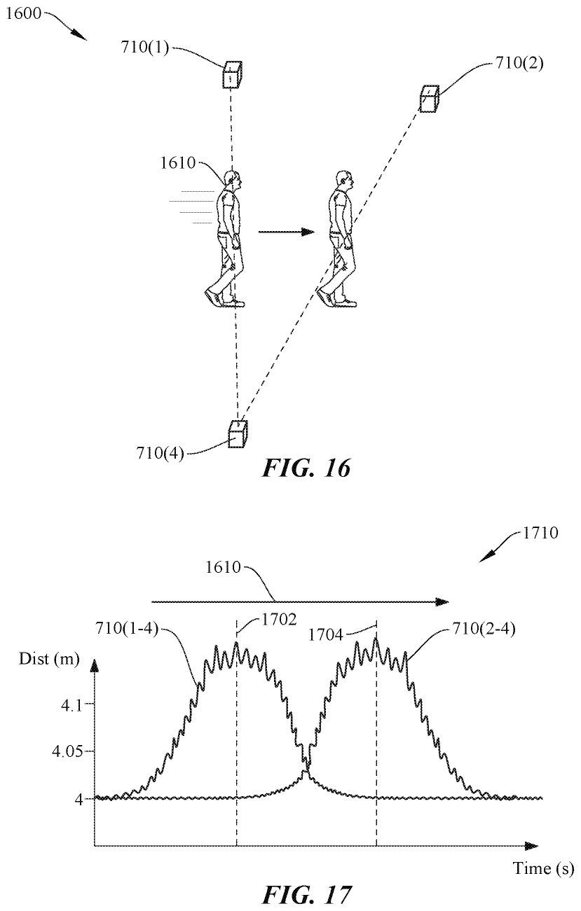

FIG. 16 shows aspects of determining a vector for a detected object, according to certain embodiments.

FIG. 17 is a simplified graph showing aspects of determining a vector for a detected object, according to certain embodiments.

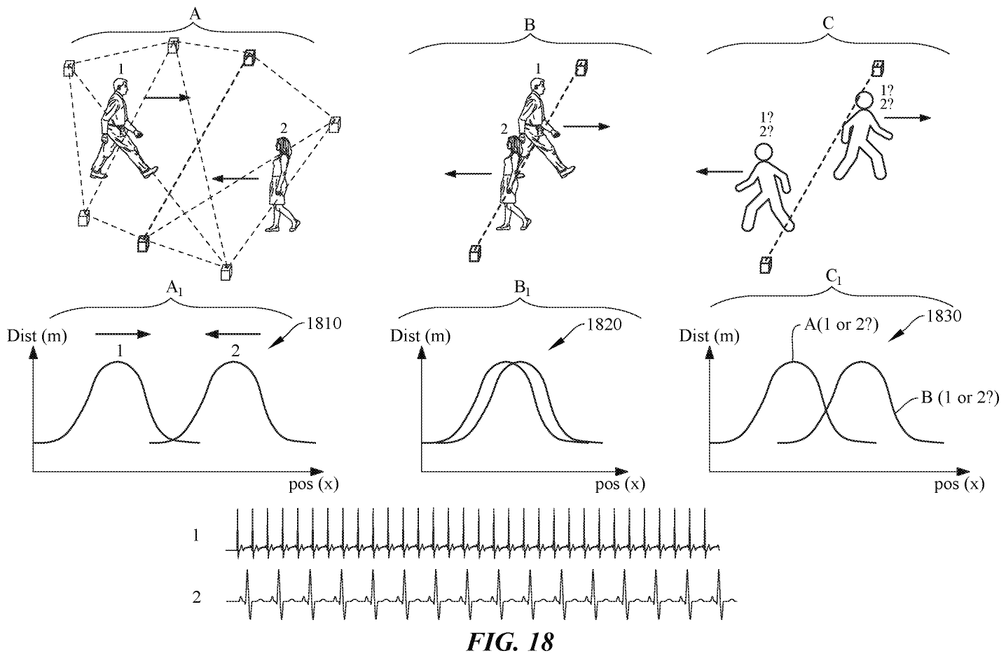

FIG. 18 shows aspects of differentiating between multiple detected objects in a configurable home infrastructure, according to certain embodiments.

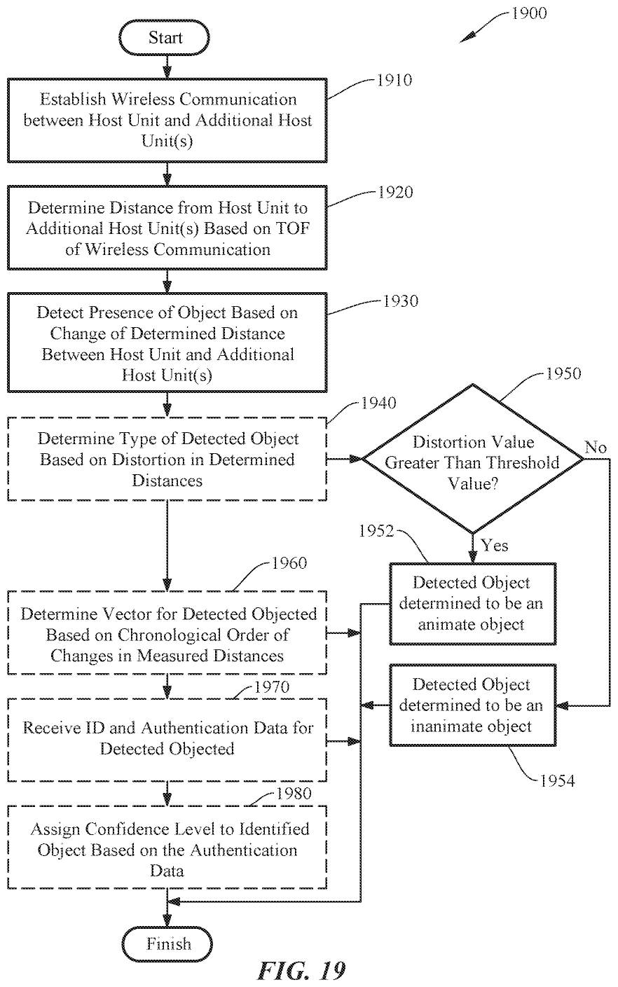

FIG. 19 is a simplified flow chart showing aspects of object detection, vector detection, and user authentication in a configurable home infrastructure, according to certain embodiments.

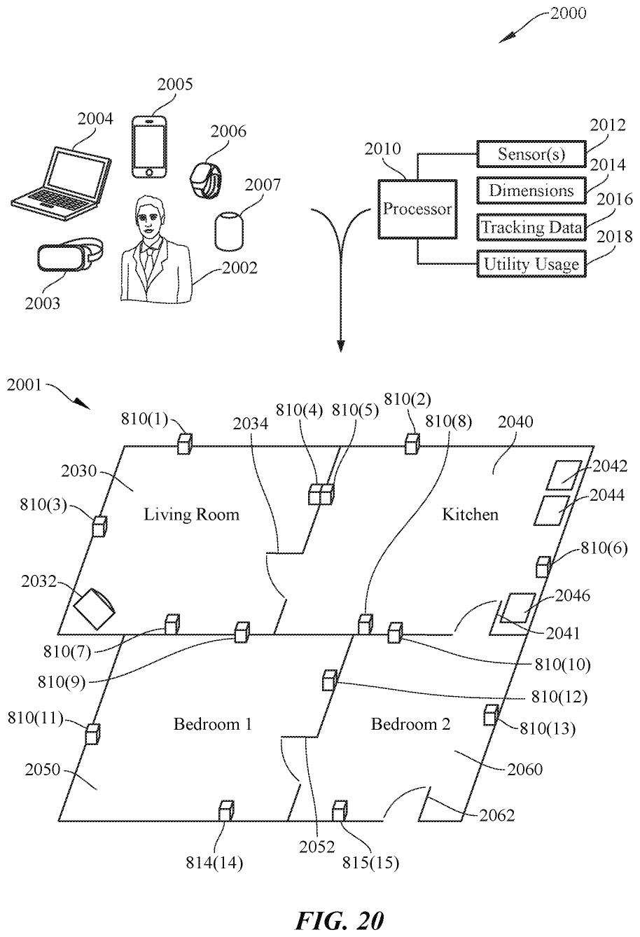

FIG. 20 shows a system configured to perform deductive floor plan generation, according to certain embodiments.

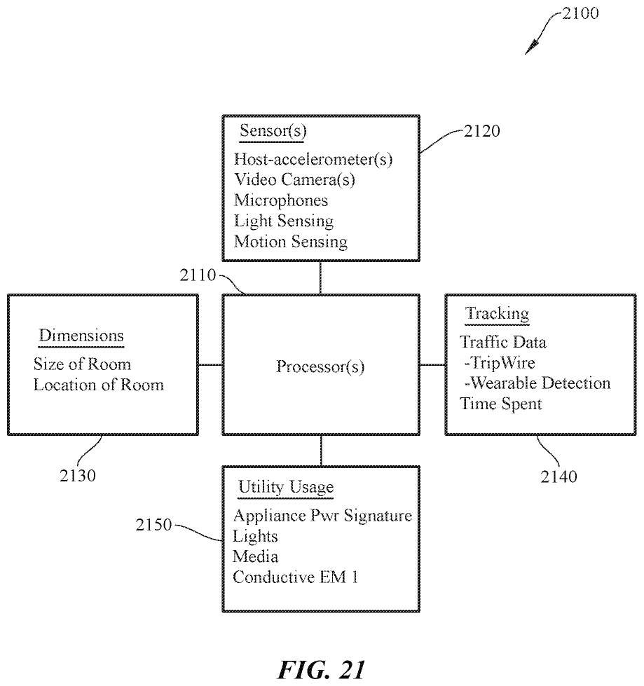

FIG. 21 shows a number of inputs that can be used by the system for deductive floor plan generation, according to certain embodiments.

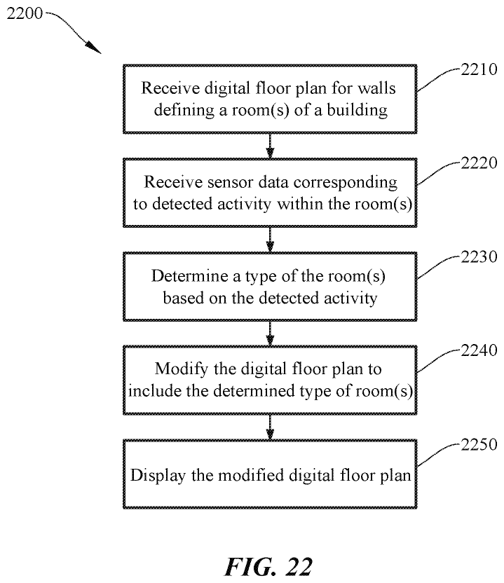

FIG. 22 is a simplified flow chart showing aspects of deductive floor plan generation using a system, according to certain embodiments.

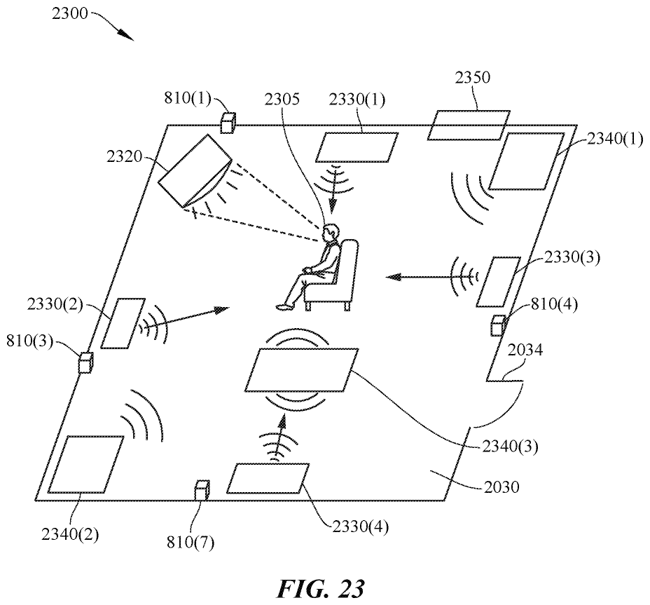

FIG. 23 is a simplified diagram showing a scene for a system configured to modify media accessories and lighting for a user based on their detected location, according to certain embodiments.

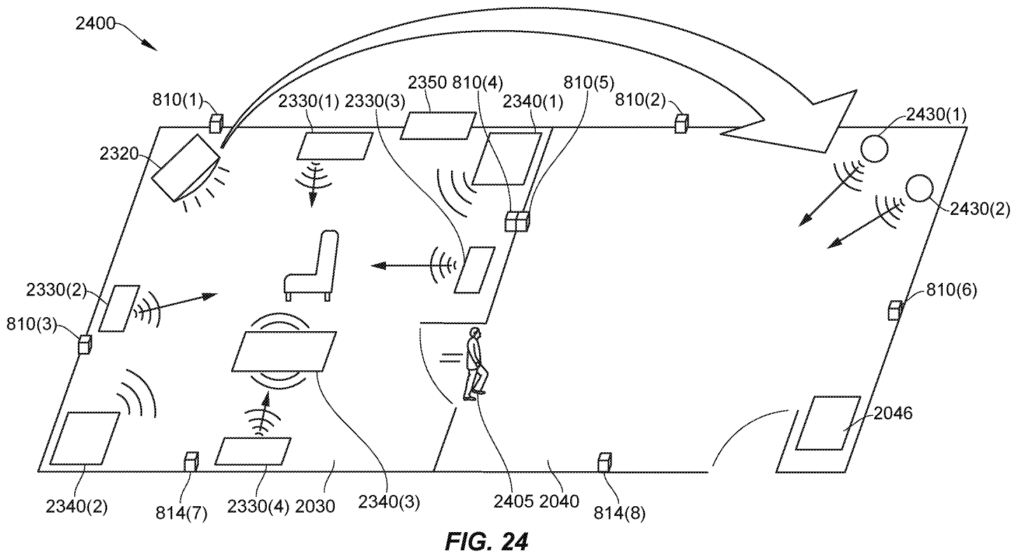

FIG. 24 is a simplified diagram showing a transition of media and lighting as a user passes from first room to a second room, according to certain embodiments.

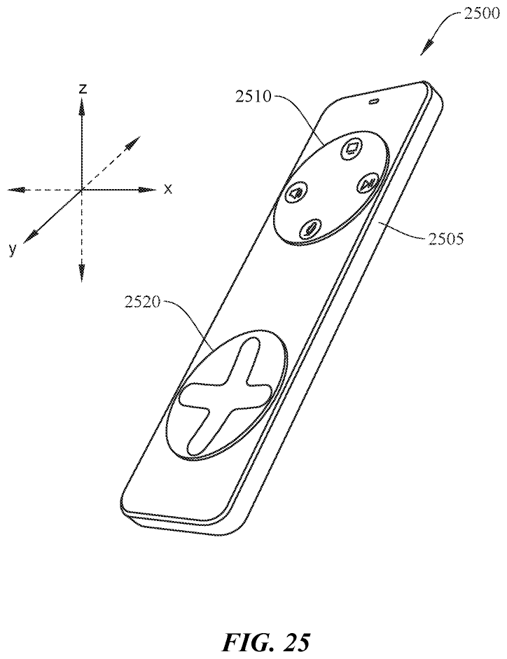

FIG. 25 shows a remote control configured to route control signals to various appliances, media, accessories, and environmental controls, according to certain embodiments.

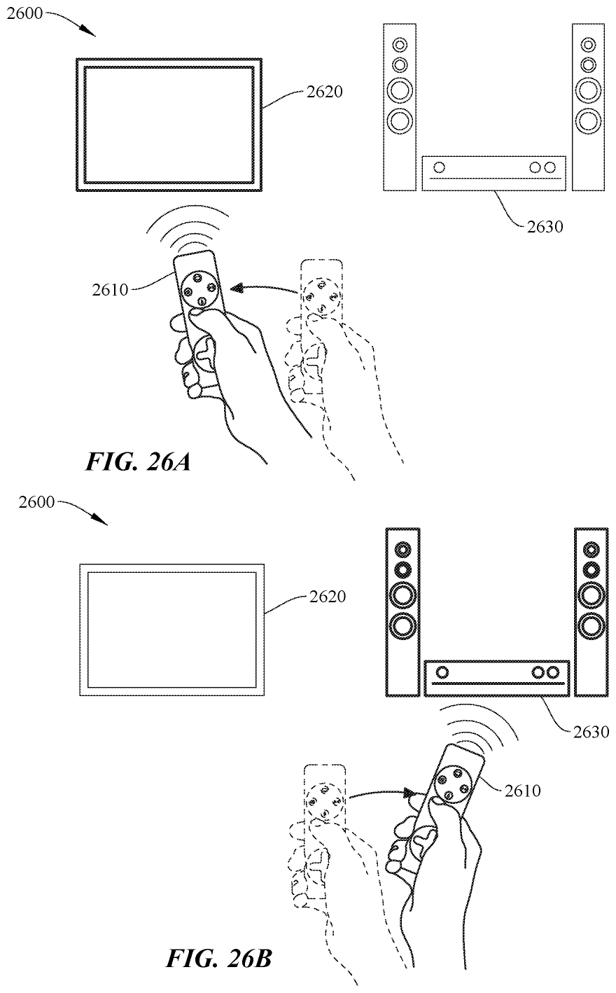

FIGS. 26A-B show a remote control directing media to a number of media accessories based on a directional movement, according to certain embodiments.

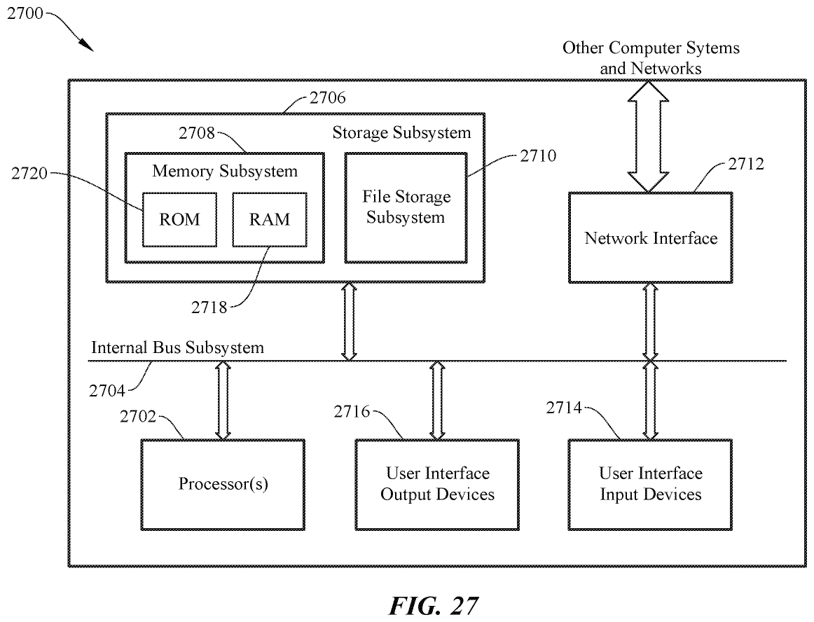

FIG. 27 shows a system for operating a controller device (brain) in a host unit-modular accessory network, according to certain embodiments.

### DETAILED DESCRIPTION

Aspects of the present disclosure relate generally to electrical systems and in particular to a modular and configurable utility infrastructure for a building.

In the following description, various embodiments of a system for configuring a smart home system will be described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

### Simplified Overview

As a general non-limiting overview, certain embodiments of the present invention can relate to a modular and configurable system for a building (e.g., residential, commercial, or industrial site) that can automatically and dynamically configure a smart building (e.g., smart home) environment as modular accessories are added and removed from the system. One of the core elements of the system include a host unit and modular accessory. The host unit (e.g., see 200 in FIG. 2A) can be embedded within (or coupled to) a structure of a building such as a wall, floor, or ceiling, and integrated with the electrical infrastructure of the home (e.g., electrical power grid, cable/Ethernet network, etc.). The modular accessory (e.g., see FIGS. 5A-5D) such as a power outlet, light switch, sensor device, etc., can be configured to be interchangeably and non-destructively coupled and decoupled with the host unit. Once coupled, the system can automatically authenticate and configure (sometimes referred to as bootstrapping) the modular accessory by, for example, coupling AC power and/or Ethernet access to the accessory, and configuring the setup and operation of the modular accessory in the smart home environment, which can include setting modular accessory control schemes (e.g., functionality and user control hierarchy) and the like, as further discussed below.

Continuing the general overview, a network of host units can be configured to communicate with one another using any suitable communication protocol (e.g., ultra-wide band (UWB), radar, ultrasound, RF, etc.) to determine a distance and location of each host unit relative to one another. Some embodiments include hardware elements (e.g., magnetometer, accelerometer, multiple antennas, etc.) to also determine an orientation of each host unit in three-dimensional space. The system can then determine and auto-generate a floor plan for the building based on the determined locations, orientations, and distances without any necessary user input or interaction. This is further discussed below with respect to FIGS. 7-9C. The system may process the distance and/or orientation data at a particular host unit, a central processing device operating as a “brain” (e.g., mobile computing device, desktop computer, etc.), an offsite cloud computing environment, or the like, or any combination thereof, as discussed in further detail below. With the determined floor plan, the system can make intuitive decisions for default auto-configuration of modular accessories.

For instance, in response to a control switch (e.g., light switch in a modular accessory) being installed in a particular host unit, the system may auto-configure the control switch to control the operation of a particular lighting element in a particular room after determining that the control switch is in the particular room and no other lighting elements or control switches are located in said room. This is but one simple example of the myriad possibilities achievable using aspects of the present invention, and the examples that follow are intended to provide a more thorough understanding of the inventive concepts described herein and should not be interpreted in any way to be limiting in terms of the breadth of application of the present invention. One of ordinary skill in the art with the benefit of this disclosure would understand the many variations, modifications, and alternative embodiments thereof. Thus, aspects of the present invention provide a smart home environment that can allow users to more easily customize, scale, and reconfigure their homes in a more effortless and user friendly manner.

Some particular embodiments may include a modular host system with a host unit installed in a support structure (e.g., wall, ceiling, floor, etc.) of a building that can receive and house a modular accessory. The modular accessory can be, e.g., a control switch (e.g., bistable switch, thermostat, etc.), power outlet, sensor module (e.g., image sensor, audio sensor, force sensor, etc.), or the like. The host unit may include a power gating module that can couple and decouple electrical power (e.g., AC or DC power) from an electrical source (e.g., utility grid, renewable energy resource, etc.) to the modular accessory, and a communication module that can communicate via hardwired (e.g., Ethernet, fiber optics, coaxial cable) or wireless communication (e.g., via ultra-wide band (UWB), radar, RF, etc.) with one or more additional host units installed in the building. In some embodiments, the communication module may perform a gating function to couple and decouple a physical network connection from a network source (e.g., Ethernet, fiber optics, coaxial) to the host unit. Distance data corresponding to a distance between the host unit and each of the one or more additional host units can be gleaned from said wired or wireless communication. In some implementations, the system can then automatically determine a floor plan of the building based at least on the determined distances from the host unit to the one or more additional host units. In some cases, each host unit can include a self-orientation module that can determine an orientation of the host unit in three-dimensional (3D) space and, in some cases, an orientation relative to the support structure it is installed in. The floor plan can further be based on orientation data from the orientation module. The orientation module can include an inertial motion unit (IMU), accelerometer, magnetometer, barometer, altimeter, one or more antennas, or the like, as further described below. Alternatively or additionally, some host units may be configured to track the relative position and orientation of a portable device (e.g., tablet computer, smart phone or wearable, laptop computer, etc.) that has a compatible communication module. Certain embodiments may employ an authentication module for additional security, as further described below with respect to FIG. 6. The modular host system can be of any suitable form factor, however particular embodiments may be operable to be retrofitted into a space configured to receive a conventional standard wall outlet, as described below with respect to FIG. 1. To provide some non-limiting implementations, the host unit can be configured to fit into a new/different space in a support structure (e.g., wall), the host unit can be a 1:1 physical substitute for the an outlet box (see, e.g., FIG. 1, element 130) as noted above, or the host unit can fit completely inside an existing outlet box, such that no complete removal of existing infrastructure may be needed, among other possible implementations. One of ordinary skill in the art with the benefit of this disclosure would understand the many variations, modifications, and alternative embodiments thereof.

Furthering the general overview, some implementations of the modular multi-host system may be configured detect the presence of an object in the building using the distance measurements between host units, determine a vector of the detected object, differentiate between multiple users by various biometrics and body mechanics, establish a confidence level that the detected object (user) is authenticated, and establish a hierarchy of privileges for the user based on the level of authentication.

As described above, host units may communicate with other additional host units to determine a distance between them as well as each of their orientations to determine a floor plan. This can be done a single time (e.g., after initial installation) using the time-of-flight (TOF) of the communications signals (e.g., UWB) to determine the corresponding distances. However, when TOF is measured multiple times (e.g., periodically (e.g., 1 s intervals), aperiodically, continuously, intermittently, etc.), variations in the distance measurements may indicate the presence of an object in the room. When an object obstructs a particular line-of-sight measurement between host units, the communication signal (e.g., UWB) may pass through the object, which can change the TOF measurement. In addition, the communication signal may be observed to take an alternative path if the shortest direct path is blocked; this will also change the TOF measurement. For instance, if a distance between two host units is measured to be 2.5 m via TOF calculations and a sofa is subsequently placed between the two host units, obstructing the line-of-sight between them, the measured distance may change as the UWB signals may pass through the sofa at a slightly slower rate than in open air or because the received UWB signals traveled an alternate path. Changes may be on the order of millimeters or centimeters, depending on the type of obstruction and the geometry of the surrounding area. For the purposes of simplifying explanation, the line-of-sight communications between host units may be thought of as operating like virtual “trip wires” that “trigger” when an objects passes between them and changes their corresponding TOF measurement. To provide context, animate objects (e.g., humans, animals) may be expected to have a typical static distortion of approximately 4-25 cm. Non-conductive objects may be 1-4 cm. Some large conductive bodies (e.g., televisions) may obstruct the line-of-sight path entirely, consequently resulting in a measuring of a shortest reflection path (e.g., off of one or more walls or other reflective objects), which can be relatively small (e.g., 2-5 cm) or relatively large (e.g., one or more meters). Note that these examples are not limiting and smaller or larger values are possible depending on the type of object. Some embodiments may employ threshold triggers for object detection. For instance, some level of distortion may be expected, even when no object is obstructing the line-of-sight (LOS). To differentiate between expected system noise (i.e., EMI, natural phenomena or other interference, etc.), some minimum detected distance (e.g., 1 cm) may be used to differentiate objects from noise. In certain embodiments, phased arrays of antennas can be used at the host units and an angle-of-signal arrival can be detected, which can both be used to determine an orientation of the host unit with respect to the other host units, but also can be used to detect objects by examining an amount of distortion in the angle-of-signal arrival signal, as described herein with respect to the distance data.

In some embodiments, distance measurements may be a primary metric used for object detection. Alternatively or additionally, a second metric can be an increase in the variance of the signal. For two nodes, there may be some base variance (e.g., 1 cm̂2). When an object is introduced into the path, especially a conductive object including human bodies, the variance may increase substantially. In some cases, the presence of a “still” human body may double or triple the variance. Alternatively or additionally, another metric can be a measured change in angle of arrival. The angular change might be situation dependent as the direct LoS path can give way to the primary reflection path. By way of example, a measurable change in the angle of arrival (e.g., +/−5 degrees) may indicate that the LoS path is obstructed.

In addition to a change in a measured distance, an amount of distortion in the measured signal, which can manifest as an amount of variation in a measured distance (e.g., snapshot measurements, measurements over time, etc.) can be used to determine a type of detected object. For example, a sofa may be constructed of uniform and inert materials, which can change the TOF measurement and measured distance, but the change may be relatively constant. On the other hand, a human being is comprised of solids and moving liquids, which can change the TOF measurement and corresponding determined distance, but can additionally exhibit relatively more distortion (e.g., continuous change) in the TOF measurements. These changes in the magnitude of a detected distortion in TOF measurements can be used to tell the difference between animate and inanimate objects, and is further discussed below with respect to FIGS. 14-15. In further embodiments, characteristics other than a magnitude of distortion can be used to determine a type of detected object. For instance, a frequency content of the noise/distortion between different object may be used, or the difference in distortion between two different sets of transmitter/receiver measurements can be used. One of ordinary skill in the art with the benefit of this disclosure would understand the many variations, modifications, and alternative embodiments thereof.

In some embodiments, a vector for the detected object can be determined in a number of ways. For example, multiple host units in communication with one another (e.g., as shown in FIG. 7 below) can create a mesh of virtual trip wires. As a user traverses a number of the virtual trip wires, a trajectory and speed can be determined, with potentially greater resolution and accuracy with a greater density of virtual trip wires, as shown and described below with respect to FIGS. 16-17.

In certain embodiments, two or more people (users) passing through a common virtual tripwire may be detected and differentiated based on one or more of their biometrics. For instance, consider the scenario where two people are walking toward each other and pass one another at a virtual tripwire. It may not be clear from the virtual tripwire measurement data if the two people passed each other and continued walking in the same direction, or if they stopped and turned around to back in the opposite direction. In such cases, biometrics such as a person's heart rate can be measured wirelessly (e.g., via a 60 GHz millimeter wave sensor (MWS) system) to differentiate between people, as shown and described below with respect to FIG. 18. Other characteristics can be used as well, including a person's detected speed, gate, size, or other features that may be particular to certain users.

In further embodiments, a detected user can be authenticated in a number of ways. For example, user data may be received that corresponds to the detected object (user). A confidence level can be assigned to the detected user based on a quality of the user data. For instance, a user's biometrics data (e.g., heart rate, iris data, fingerprint data, gate, size, etc.) may increase the confidence level that the detected user is who they purport to be. If the user has a cryptographic key, password, or other data, the confidence level can be increased as well. Certain permissions can be assigned to the detected user based on the confidence level. For example, if the user has a password only, then they may not be granted access to resources (e.g., home security controls, safe access, etc.) or certain areas of the home. If that user also has a cryptographic key and their detected heart rate matches characteristics of a stored heart rate associated with the user, then the confidence level may be high enough to grant full access to all resources and locations in the home, assuming that the particular user was authorized to do so, as shown and described below with respect to FIG. 19. In some cases, a detected heart rate, or any of the other methods of authentication, may be afforded higher or lower values of influence (e.g., weighted value) for affecting a determined confidence level. One of ordinary skill in the art with the benefit of this disclosure would understand the many variations, modifications, combinations, and alternative embodiments of the various concepts described above and throughout the remainder of this disclosure and would appreciate that any combination of these concepts may be possible unless expressly indicated otherwise.

To improve the understanding and purview of the embodiments that follow, some of the terms used throughout the present disclosure are described herein. A “floorplan” can be a representation (e.g., a digital representation) of a complete or partial structural layout of a building. A floorplan can be the same as a blueprint. The floor plan can represent the locations of various structures, objects, etc., within the building, including dimensions and locations, as well as distances between said structures and objects, as would be appreciated by one of ordinary skill in the art with the benefit of this disclosure. The floor plan can be an output (e.g., rendered on a display for a user, printed on paper) or a digital file accessed, updated, processed, etc., by the systems described herein.

A “support structure” can be a structural element of the building, such as the walls, floor, ceiling, support column, chimney, or the like. In some embodiments, the support structure may not be structurally integrated with the building and can include a table, chair, appliance, couch, cabinet, or the like. That is, host units can be integrated with (installed in, coupled to, etc.) any support structure and one of ordinary skill in the art with the benefit of this disclosure would understand that the embodiments described herein are not limited and other implementations, though not explicitly described, would still fall within the purview of the present disclosure.

A “building” can be any enclosure with one or more walls and may include residential, commercial, or industrial structures, structures with or without a ceiling or floors (e.g., a walled enclosure such as a stadium, tent structure, etc.), or the like. A building can be referred to as a “structure,” not to be confused with a “support structure,” as defined above.

A “modular accessory” can be an accessory that is a self-contained unit that, for example, can be repeatedly installed and removed from the host unit. A modular accessory may be referred to as a module, and examples of the various accessories are shown and described below at least with respect to FIGS. 3A-3B and 5A-5E. In some cases, certain embodiments may employ accessories that are not modular; that is, the accessory can be installed but is not necessarily easily installed/removed in the manner described in the embodiments that follow. One of ordinary skill in the art with the benefit of this disclosure would appreciate the many modifications, variations, and alternative embodiments thereof

FIG. 1 shows a simplified diagram of a conventional wall-mounted power outlet 100 commonly found in residential, commercial, or industrial buildings or structures. Conventional power outlets are typically coupled to an alternating current (AC) power supply in a building, which can be sourced by an electrical power grid comprising power from a local power company, a renewable energy array (e.g., wind power, solar power, local generator, etc.), uninterruptible power supply system, or other suitable power supply and in any combination thereof. AC power is typically set to 120V at 60 Hz in North America, and 220V-240V at 50 Hz in Europe. The outlets and corresponding plugs used in each country are usually set by national standards, some of which are listed in the IEC technical report TR 60083.

Conventional power outlets have not changed much in terms of function or design for over a century. In the U.S., conventional power outlets are fixed and hardwired such that they cannot be easily modified without substantial retooling and disassembly. Referring to FIG. 1, power outlet 100 can include a faceplate 110, receptacle 120, and outlet box 130. Faceplate 110 is typically fastened to receptacle 120 via hardware (e.g., screws), receptacle 120 (terminal block) is typically mounted to outlet box 130 via retaining screws and may include terminal screws, grounding screws, or other hardware fixtures to secure and couple electrical wiring to receptacle 120. Generally, any modification to the electrical circuit will require some amount of additional circuitry (e.g., adding a universal serial bus (USB) circuit and socket) will likely involve substantial disassembly, rewiring, and replacement items (e.g., new receptacle 120 and/or outlet box 130) to accommodate the changes, and a thorough knowledge of the relevant portions of the National Electric Code (NEC) to ensure compliance. More fundamental changes (e.g., replacing a power outlet with a thermostat controller or sensor device) would require even more specialized knowledge including installation and wiring of the new hardware and corresponding infrastructure. As such, conventional wall outlets are fixed, hardwired, and generally not modifiable without significant time, equipment, and experience to comply with the NEC. In some jurisdictions, modifications may not be allowed by a user. Local codes may require a licensed electrician and/or permits to perform such modifications.

### Exemplary Host Unit and Modular Accessories

In contrast to the fixed and hardwired conventional implementation of an electrical power outlet described above, aspects of the present invention can include a host unit (also referred to as a “host device” or “host module”) that can be configured to couple to (and non-destructively decouple from) a modular accessory to provide electrical power and other functional capabilities as described below. The host unit is configured as a universal socket to receive a uniformly sized modular accessory housing, which can contain any suitable functional capabilities (e.g., see FIGS. 5A-5D). In some implementations, the host unit may be sized to be retrofitted inside existing cavities where conventional electrical power outlets, switches, and/or electrical fixtures are located in a building (e.g., residential home). However, host units and their corresponding modular accessories may be configured in any suitable size, dimension, shape, and/or contour.

FIGS. 2A and 2B show simplified diagrams of a host unit 200, according to certain embodiments. Host unit 200 can include a faceplate 210 and sleeve insert (“sleeve”) 220. Sleeve 220 can be configured to form a cavity that extends rearwards from and normal to the surface of faceplate 210. Sleeve 220 can be operable to receive and secure a modular accessory such that when host unit 200 is installed and embedded in a support structure (e.g., wall), faceplate 210 can be flush or substantially flush (e.g., offset and parallel) to the surface of the support structure with sleeve 220 embedded therein. Note that the support structure will be referred to in the following examples as a wall, but it should be understood that a support structure can also include a floor, a ceiling, a column, a pillar, a half-wall, an appliance, or any other suitable building structure that can provide the appropriate electrical infrastructure (e.g., AC power), as would be appreciated by one of ordinary skill in the art with the benefit of this disclosure. Further, some of the examples provided herein may refer to the building as a “home,” however it should be understood that “building” may refer to any residential, commercial, or industrial structure or dwelling.

In some embodiments, sleeve 220 may include a junction board 230, controller board 240, and power gating board (“power gate”) 250, among other boards, modules, and/or features. Controller board 240 can include a microcontroller and a communication module configured to determine relative distances to other host units via suitable communication protocol (e.g., UWB, radar, ultrasound, etc.). In some cases, the controller board 240 may include an IMU, accelerometer, compass, magnetometer, one or more antennas, or the like to determine a self-orientation in 3D space. Power gate 250 may be configured to couple electrical power (e.g., AC and/or DC power) from an electrical source (e.g., electric utility grid, generator, local renewable resource (e.g., solar system), or the like) to the modular accessory. In some embodiments, junction board 230 can further couple Ethernet data lines (e.g., copper, fiber optic cables, etc.) or other type of data line to the modular accessory. In some cases, the electrical power and data lines may not physically couple to host unit 200 as an intermediary node and can operate as a pass through device, such that host board 200 does not actually receive or interface electrical power or data. Junction board 230 can include hardware, harnesses, contact boards, connectors, or the like to facilitate physically and electrically mating host unit 200 with a modular accessory. More details about the various components of boards 230-250 are shown and described below with respect to FIG. 4. Although boards 230-250 are shown to occupy a certain area of sleeve 220, it should be understood that the various components, boards, modules, etc., may be productized to accommodate any suitable size, dimensions, layout, or other design metric. One of ordinary skill in the art with the benefit of this disclosure would understand the many variations, modifications, and alternative embodiments thereof.

FIGS. 3A and 3B show how a modular accessory 330 can be coupled to a wall-mounted host unit 310, according to certain embodiments. Host unit 310 is shown as installed and embedded in building support structure (e.g., wall 320). Modular accessory 330 can be coupled to host unit 310 by sliding into a sleeve (cavity) via a frictional fit, tracks or insert guides, or other suitable method. Host unit 310 may be connectorized such that modular accessory 320 physically and electrically couples to host unit 310 when fully inserted. Alternatively or additionally, wire harnesses or other methods of mechanically and/or electrically coupling modular accessory 320 to host unit 310 can be used. In some cases, when modular accessory 330 is fully inserted and mechanically/electrically coupled to host unit 310, modular accessory 330 may be configured to be flush against a surface of the wall, as shown in FIG. 3B. Host unit 310 and modular accessory 330 can be of any suitable form factor and can couple to support structure 320 in any suitable arrangement. One of ordinary skill in the art would understand the many variations, modifications, and alternative embodiments thereof.

FIG. 4 shows a simplified block diagram of a system 400 for operating a host unit, according to certain embodiments. System 400 may include a controller block 410, DC power block 420, data path 430, self-orientation detection (“orientation”) block 450, and power gating block 460. In certain embodiments, controller block 410 may include one or more microcontrollers (MCUs) and can be configured to control the operation of system 400. Alternatively or additionally, processor 410 may include one or more microprocessors (μCs), digital signal processors (DSPs), or the like, with supporting hardware, firmware (e.g., memory, programmable I/Os, etc.), and/or software, as would be appreciated by one of ordinary skill in the art. Alternatively, MCUs, μCs, DSPs, and the like, may be configured in other system blocks of system 300. Microcontroller block 410 may include a radio 415 and antenna system to communicate with one or more additional host units via UWB, radar, ultrasound, RF, Bluetooth, Bluetooth LE, synchronous (or asynchronous) IR blaster, ZigBee, Z-Wave, or other suitable communication protocol. Radio 415 can be used to determine a relative distance and ranging from the host device to the one or more additional host devices in a building (e.g., via time-of-flight calculations, received signal strength indicator (RSSI) measurements, etc.). In some embodiments, the host unit collects the raw communication data and another entity (e.g., brain) performs the distance calculations, as further described below at least with respect to FIGS. 11A-11C. Furthermore, any suitable communication protocol can be used for communication between host units and corresponding modular accessories. For instance, a wireless communication protocol, such as near-field communication (NFC) protocol may be employed in the embodiments described in the present disclosure, or any other medium of communication, as would be appreciated by one of ordinary skill in the art with the benefit of this disclosure.

In some embodiments, microcontroller block 410 may can include a DC universal asynchronous receiver/transmitter (UART) to provide a DC communication path between the host unit and modular accessory to allow the modular accessory to automatically bootstrap itself when plugged in. For example, in some embodiments, the microcontroller may query the modular accessory when connected to identify what it is, identify its capabilities, provide the modular accessory credentials (e.g., Wi-Fi login name, password, etc.), etc., to allow the modular accessory to self-power and bootstrap itself automatically without any user interaction. In some embodiments, an alert can be sent to a user (e.g., home owner via SMS text) requesting permission to accept and configure the modular accessory.

DC power block 420 can provide 100 ma-2 A @ 5V to power the basic features of a one or more blocks of the host unit and modular accessory (e.g., MCU, Radio, etc). When the modular accessory is inserted, the host can enable <100 mA power delivery (see, e.g., element 612 of FIG. 6) to allow the modular accessory to boot up. The module may then request additional power to enable the rest of its functionality (see, e.g., element 616 of FIG. 6). After authentication, the host unit can enable full power mode and allow the modular accessory to bring up all of its components, as further discussed below with respect to FIG. 6.

In some cases, DC power block 420 can be configured to enable higher power DC delivery (e.g., USB-C @ 100W or 48V @ 1 kW, or other suitable power requirement). In some implementations, only DC power may be provided by a host unit. For instance, there may be relatively few classes of devices that operate directly on AC power, such as resistive heaters and lights (e.g., stoves, space heaters) and induction motors (e.g., vacuums, pumps, compressors, refrigerators, etc.). Many consumer devices may rely on a “wall-wart” (transformer box) for AC/DC conversion, and would benefit from a direct DC power source rather than AC as they could connect to the wall with just a cable. For example, some laptops may use an 85W AC/DC converter with a USB-C connection from the converter to the laptop. With DC power delivery in the host unit, the converter could be removed and the laptop could be powered by a USB-C cable connected directly to a modular accessory. In some home implementations, floor level host units may be configured to provide AC power to large appliances, and mid or high level host units may be configured to provide DC only to control light switches/sockets (e.g., DC-driven LEDs), controls, sensors, or the like. However, any suitable implementation of AC only, AC/DC, and DC only infrastructure can be used, as would be appreciated by one of ordinary skill in the art with the benefit of this disclosure.

In some embodiments, two DC power blocks may be employed instead of one (depicted in FIG. 4). For example, a low-power DC block may be dedicated for powering a modular accessory and a second high-power DC block may be configured to power appliances or other high-power devices. For instance, the low-power DC block may be active on each host unit (or a subset thereof), and it would provide enough power to power the essential parts of the host unit and/or modular accessory (e.g., MCU, radio, sensors), but not elements that are high power (e.g., lights, touch screen/display, digital content manager (e.g., Apple TV®)) or devices that are plugged into the modular accessory. In some cases, a UART connection may be implemented as a separate electrical connection, or layered as a single wire protocol carried on the low-power DC connection. Modules that have high power elements, or devices plugged into a module that need more power may require that the module either integrate an AC/DC converter and connect to block 460, or connect to block two (high-power DC). One, two, or more DC power blocks can be used in any combination of function or use, as would be appreciated by one of ordinary skill in the art with the benefit of this disclosure.

Data path 430 can be copper cables, fiber optic cables, coaxial cables, or other suitable data traffic medium. In some embodiments, data path 430 may not directly couple with the host unit, where the host unit operates as a pass through entity allowing data to travel directly from the data source to the modular accessory. This may be advantageous as communication technology continually improves, increasing data rates and bandwidth capabilities will not be hampered or affected by aging technology in the host unit.

There may be many different implementations to mechanically, electrically, and/or optically coupling to a networking source. For instance, in mechanically-based embodiments, a fiber optic cable can be mechanically attached to the host unit, with the end of the cable exposed so the modular accessory could make optical contact. In some cases, a fiber optic network may be opaque to the host (e.g., there can be a mechanical shutter on the host unit to gate the end of the fiber so the laser is not exposed without a modular accessory plugged in). In certain embodiments, one of fiber, Ethernet, USB-C/Thunderbolt, etc., can be coupled to the host unit, which would undergo a 1:1 conversion to an electric signal (in the case of fiber) without requiring a decoding of the protocol. That is, the signal can be passed to electrical-to-optical couplers or an optical lensing solution, which can be positioned to optically couple the output to an inserted modular accessory. The received signal can then be reconverted to the appropriate network physical interface and decoded on the modular accessory.

Orientation block 450 can be used to determine an orientation of the host device in 3D space. Orientation block 450 can include an accelerometer, gyroscope, magnetometer, compass, IMU, one or more antennas, or other suitable device. In certain implementations, an accelerometer is used to determine the direction of gravity (normal vector), and a compass (e.g., magnetometer) is used to determine the orientation of the host device relative to the normal vector. Although the embodiments described herein associate location (distance) and orientation detection with the host unit, it should be understood that location and orientation detection devices can be alternatively or additionally included in the modular accessory. In some embodiments, multiple antennas (e.g., a multi-antenna array) can be included in host unit 400 and may be configured to communicate with one or more additional host units, each configured with multiple antennas. In such embodiments, communication data can be sent and received between host units and an orientation of the host units with respect to one another can be determined because each set of multiple antennas can operate as a phased array such that a phase angle of arrival of the communication data can be determined, which can correspond to said relative orientations of the host units. Such embodiments with multiple antennas (also referred to as “phased arrays” or a “phased antenna array”) can be implemented in addition to or in replace of the accelerometer and compass implementations discussed throughout the present disclosure.

Power gating block 460 can control the coupling of electric power (e.g., AC power) from a power source (e.g., electric utility grid, local renewable energy resource, generator, energy storage device, etc.) to the modular accessory. Gating may be implemented via an on-board relay that can be turned on and off based on the connection status between the host unit and modular accessory. For example, AC power can be turned on (allowed to pass from the power source to the modular accessory) in response to the modular accessory being mechanically and/or electrically coupled to the host unit. Conversely, AC power can be turned off when the modular accessory is electrically and/or mechanically removed from the host unit. This can serve as a safety mechanism so that a user cannot be electrocuted when touching an empty (uncoupled) host unit. In some embodiments, power gating block 460 can be configured to sense voltage, current, frequency, and power factor of AC power delivery.

It should be noted that the host unit, in some examples, can be intended for long term operation (e.g., 40+ years) and is designed such that its functions will not age out as new technology continues to develop. This can be advantageous as the host unit installation process is likely to occur once, such as when a home or commercial building is built, or when an electrical system is replaced or overhauled, as the host unit typically requires specialized knowledge for NEC compliance. Conversely, any number of modular accessories can be easily installed (e.g., plugged in), removed, and replaced by a user as new technologies are developed and integrated therein. Some of the host unit functions that are not likely to change for potentially decades include the authentication and bootstrapping process, the AC gating, and the ranging/orientation capabilities, although some embodiments may still include upgrades for ranging and orientation, which may supersede or augment existing hardware in the host unit. The authentication/bootstrapping process can be limited to processing, communicating, and storing of very small amount of data (e.g., 10 KB) and may not change over time. AC power will presumably remain the same for decades to come, as conventional wall sockets have performed that same function for over 100 years. Similarly, the relay and control circuit to engage/disengage AC power with the modular accessory can have a long operating life. However, some embodiments may allow certain components (e.g., the AC gating relay, microcontroller, crypto-co-processor, authentication module, secure enclave modular, etc.) to be socketed and user-accessible for part replacement if necessary. In some embodiments, providing a pass through for data cables may not need any upgrades for decades as the host unit does not operate as a node in the data path, as further described above. This can be particularly true with fiber optics, as contemporary electronics has not reached a full utilization/bandwidth of this communication medium and further improvements will be made in the coming years. Technological advances and upgrades may occur in the modular accessories and/or brain of the home, which can be easily be installed/removed as needed without rewiring, configuring, or adjusting the host units.

FIG. 5A-5D include a set of simplified diagrams showing some typical modular accessories, according to certain embodiments. Modular accessories can include any electronic device that utilize the electrical power and data provided by a host unit. Some examples include a control switch (e.g., for switching or dimming a light) as shown in FIG. 5A, a power outlet as shown in FIG. 5B, an image sensor as shown in FIG. 5C, a thermostat controller as shown in FIG. 5D, or the like. Other examples can include an occupancy sensor, baby monitor, touch screen/home control panel, an AC/DC converter, a digital content manager (e.g., Apple TV®), wall speakers (e.g., standalone or HomePod configurations), an in-wall dedicated digital assistants (e.g., Amazon Echo ®, Google Home®, etc.), 60 Ghz transceiver for wireless connections to devices within a room (e.g., AR/VR headsets, HDMI to TV, Wireless computer monitor, etc.), security cameras (standard or privacy secured camera/sensor), phone docks (e.g., for wireless charging, syncing a smart phone/wearable to a house), lights (e.g., sconces, light sockets, etc.), security system interfaces, wireless routersmodems, NAS, and more, as would be appreciated by one of ordinary skill in the art with the benefit of this disclosure.

In further embodiments, some wall plates can be extended to support multiple modular accessories (e.g., for switches, outlets, etc.) without requiring multiple adjacent host units. In a conventional wall unit (as shown in FIG. 1), this would not be possible as two gang junction boxes would be needed to fit two switches next to each other. Thus, some embodiments may employ an electrical connector on any side of a faceplate of the modular accessory (e.g., with a method of mechanically coupling them via hardware, magnets, etc.), so that an additional and potentially different type of modular accessory can be connected, as shown in FIG. 5E. Modular accessories may be a thin variant as shown (effectively just the faceplate) that can snap onto either side of an existing modular accessory. Such embodiments can allow for a single host unit to couple to a single modular accessory that can then be extended to multiple additional modular accessories (e.g., switches, control panels, sensors, etc.) that can couple to the single modular accessory, as shown in FIG. 5E. One of ordinary skill in the art with the benefit of this disclosure would understand the many variations, modifications, and alternative embodiments thereof. In further embodiments, adjacent accessories may be electrically, magnetically, and/or communicatively isolated from one another.

### Automatic Bootstrapping of a Modular Accessory

FIG. 6 shows a sequence chart 600 showing an operation of a bootstrapping protocol for modular accessories, according to certain embodiments. Sequence chart 600 depicts communications and functions between a modular accessory 602, host unit 604, brain 606, and user 608. Brain 606 may be a computing device (e.g., desktop computer, mobile device, smart device, laptop computer, etc.) to perform some or all of the data heavy computations including determining relative locations of the host units relative to one another, determining the orientations of the host units, determining a floor plan based on the raw distance data, and other functions, as further described below with respect to FIGS. 7-13. It should be noted that the following set of sequences corresponds to certain embodiments, and other sequences and/or minor changes or modifications are possible, as would be appreciated by one of ordinary skill in the art with the benefit of this disclosure.

At 610, modular accessory 602 is inserted into host unit 604, which enables a low power mode of operation (612) to provide mobile accessory 602 with a baseline of resources (e.g., DC power) to power up and begin the authentication process. At 614, modular accessory 602 boots its on-board microprocessor and accesses an identification database using the available lower power provided by host 604. Mobile accessory 602 may then then request permissions and resources from host unit 604 to enable a full power mode (616). At 618, host unit 604 requests ID authentication data from modular accessory 602. Modular accessory 602 may retrieve the ID authentication data from the identification database and provide it to host 604 (620). In response to determining that mobile accessory 602 is authenticated, host 604 can enable a full power mode to modular accessory 602 (622). For example, host unit 604 may provide AC power, high power DC, and Wi-Fi and/or Ethernet access to modular accessory 602 once authentication is confirmed. In some embodiments, the ID authentication request (618) and response (620) can occur before the request for full power mode (616). More specifically, enabling low power mode of a modular accessory (612) may occur immediately before or in lieu of authentication.

In some embodiments, a modular accessory may be fully authenticated so that the system can identify its ID, functions, resource requirements, etc., however it may still need to be authorized. For instance, at 632, host 604 may query brain 606 to authorize modular accessory 602 to be added to the system network (e.g., system 400). In some instances, brain 606 may interface with a user for final approval of the authorization. For instance, at 624, the system may notify a user that a modular accessory has been connected and is requesting authorization and resources. Notification can be made via SMS text, email, voice call, local audio and/or video notification, or other suitable method of alerting the user. In some cases, authentication may require a user response approving the requested installation and authentication. In some cases, the user can be queried via an authenticated device, such as the host, another authenticated module, a smart device, smart wearable, computer, or the like (626). Some embodiments may authenticate after the user is authenticated through an authenticated device, which may occur via password, faceID®, touchID®, biometrics, voice recognition, or the like (628). Alternatively or additionally, a passive authentication algorithm can be used to authenticate the installation and configuration of modular accessory 602. For example, a camera or image sensor can visually identify that an authorized user is the person plugging in module 602 (630). In certain embodiments, different users may have different levels of authorization. For example, User A may be allowed to install any module with a visual ID, User B may be required to authenticate using an external method (e.g., phone, touched), and User C may only be allowed to visually authenticate switches, but any other type of modular accessory (e.g., power outlet or speaker) would require external authentication. One of ordinary skill in the art with the benefit of this disclosure would understand the many variations, modifications, and alternative embodiments thereof.

Once authorized (e.g., automatically or per user approval), brain 606 may respond to host 604 indicating that the authorization for modular accessory 602 is granted (634) and host 604 can freely exchange keys with modular accessory 602 (636). At this point, AC, high power DC, WAN access, LAN access, Wi-Fi, etc., can be provided to modular accessory 602 via host 604 and key exchanges, data requests, etc., can be provided by brain 606 (steps 638-644).

### Host Unit Ranging, Self-Orientation Detection, and Auto Floor Plan Generation

FIG. 7 shows a simplified diagram of a number of host units in communication with one another in a configurable home infrastructure, according to certain embodiments. Each host 710(1)-(5) (or a subset thereof) can be communicatively coupled to one another via any suitable communication protocol, such as UWB, radar, ZigBee, Z-Wave, Bluetooth, BTLE, ultrasound, LIDAR, laser, any suitable optical communications protocol, or the like. A distance between the host units can be derived from the communication signals (e.g., via time-of-flight calculations, RSSI, phase-shift, etc.). Alternatively or additionally, a host unit can determine if it shares a wall cavity with another host unit, as well as if it shares a joist/stud cavity with another host unit, via the communication signals and/or IMU (e.g., vibration detection). In some cases, the computations to determine the distances may be performed at the host units, by installed modular accessories, by aggregators, by a system brain, or a combination thereof. Each host unit may further determine their orientation in 3D space, as described above. In certain implementations, one host unit or a subset of the total number of host units may communicate with each additional host unit in a building for a different communication infrastructure, as would be appreciated by one of ordinary skill in the art with the benefit of this disclosure.

FIG. 8 shows a simplified diagram showing an automatically generated floor plan for a home, according to certain embodiments. The building includes four rooms (Rooms 1-4), with each wall having four walls (a-d). Each host unit 810(1)-(15) or subset thereof may be in communication with one another and relative distance data can be determined based on time-of-flight measurements between each host device. Alternatively or additionally, a relative orientation of host units can be determined using a phase angle of arrival when the radio consists of multiple antenna elements (e.g., phase array) configured to enable the collection of this information. Each individual host unit may represent a single point in a point cloud, as represented in FIG. 9A. Each host unit can further include orientation data, which can be used to determine a direction that the host unit is facing in each room.

In certain embodiments, the relative distance data and detected corresponding relative locations of each host unit can be used to automatically generate a floor plan. For example, a plurality of host units (e.g., 3 or more) that are determined to be co-linear along a same or substantially same plane can be used to identify a potential wall in the floor plan model, as shown in FIG. 9B. A potential wall can also be determined by sets of host units that share a wall, joist, or stud cavity. In some aspects, a co-linear plurality of host units configured in orthographic planes may be used to define walls in a floor plan model, as shown in FIG. 9C. In certain embodiments, the systems can use a sketched model of the floor plan (e.g., stored in a database) and use distance data from the home units to refine and fit the walls to the same general shape. Other methods of point cloud analysis (e.g., least squares) can be used to determine the location of walls in a home and one of ordinary skill in the art with the benefit of this disclosure would understand the many variations, modifications, and alternative embodiments thereof.

In some arrangements, two or more host units may appear to have point locations that are co-located at a same location or substantially the same location (e.g., within 30 cm from one another). It may be possible that the host units are configured in immediately adjacent locations on the same side of a common wall or on opposite sides of a common wall. In such cases, orientation data may be used to resolve these types of indeterminate scenarios. For example, referring to FIG. 8, host unit 810(4) and 810(5) may represent two points in a point cloud that are very close in proximity. If their measured orientations are determined to be facing opposite direction, the corresponding floor plan model may be configured to place the host units on opposite sides of a common wall. If the orientations are determined to be facing the same direction, then the floor plan model may place the host units on the same side of a common wall. For example, the host units may be configured side-by-side (e.g., control switch and thermostat), or vertically displaced, but in the same or substantially the same X-Y location in the floor plan (e.g., a control switch configured at lm from the floor, and a power outlet at 0.2m from the floor).

In some embodiments, modular accessory functionality can be used to improve the accuracy of an auto-generated floor plan. For example, some modular accessories may include an ambient light sensor (ALS). If the smart home is aware that a light is on in Room 1 and the modular accessory for host 810(4) detects the light, then the floor plan may reflect that host unit 810(4) is located in Room 1. Conversely, if the modular accessory for host unit 810(5) does not detect the light, then the floor plan can reflect that host unit 810(5) is located in Room 2 because the light would not reach that location with the intervening wall. In another example, audio from a television in Room 1 may be periodically detected at different sound levels by a microphone embedded in a modular accessory coupled to host 810(8), which may be determined to correspond to a door opening on the wall (1b/2d) separating Rooms 1 or 2. Other floor plan enhancing and/or supplementing implementations are possible, as would be appreciated by one of ordinary skill in the art with the benefit of this disclosure.

In summary, certain implementations of floor plan generation may use “ranging only” and “ranging and orientation”-based systems, and may further incorporate implementations using supplementary sensing and/or other techniques, as described in the non-limiting summaries that follow. Note that an angle of arrival can be incorporated into the following enumerated summaries to further determine ranging and/or orientation, as would be appreciated by one of ordinary skill in the art with the benefit of this disclosure.

### Overview of Floor Plan Generation Using Ranging Data

1. Obtain distance for all of a subset of possible host-host pairs using wireless ranging.
2. Create a point cloud using a least squares error-based Trilateration algorithm or other suitable substitution, as would be appreciated by one of ordinary skill in the art.
3. From the point cloud, generate a list off sets of three or more hosts that are coplanar.
4. Create a set of possible walls (lines) from the coplanar set, and determine the intersection angle of the pairs (e.g., see FIG. 9B).
5. Build an estimate of the floor plan by constraining set of possible walls to those that are orthogonal to each other (e.g., see FIG. 9C), and eliminate edges that are not enclosed. Note that, with just wireless ranging, the waveguide characteristics of wall cavities allow for further identification of host units that share that a wall cavity. This can be used to increase the accuracy of the floor plan estimate by further constraining the set of possible walls. In some embodiments, a floor plan can be generated using a maximal set of possible orthogonal walls. In some cases, the walls may not need to be orthogonal to be determined to be a wall, for example, if enough points (e.g., four or more) support the existence of a non-orthogonal wall.

### Overview of Floor Plan Generation Using Ranging and Orientation Data

1. Obtain distance for some or all possible host unit-to-host unit pairs using wireless ranging.
2. Determine orientation of host units using some combination of accelerometer, gyrometer (gyroscope), and compass. Some embodiments may employ any suitable IMU device, magnetometer, barometer (for determining an elevation of a host unit), or other orientation and/or position determining technology.
3. Create a point cloud using least squares error based Trilateration algorithm or other suitable method.
4. Sort hosts into groups based on their normal vector. Host units may have a fixed orientation relative to the wall they are installed in and the normal vector can be the vector normal to the wall and facing into the room in which the host is installed.
5. Use point cloud and normal vector to group host units by room.
   a. Generate list of coplanar host units.
   b. Create possible set of walls from the coplanar set, use normal vector to separate coplanar host units onto different sides of each wall.
   c. Opposite sides of a room can be defined by two possible walls that are parallel where the normal vector of host units on both walls are facing towards each other, and there is not another parallel wall bisecting the space in between.
6. Generate floor plan by combining possible walls with generated rooms.
   Overview of Floor Plan Generation Using Supplementary and/or Alternative Detection Resources

Any of the techniques that follow can be combined with other sources of data to improve floor plan accuracy. Other non-limiting examples of sources of data can include: Roomba mapping, LIDAR, VR/AR base stations, user inputs, RADAR, acoustics (ultrasonics), light, and modular accessory ID. For acoustics, acoustic information can be used to determine possible room makeup, or instance, by generating sound and listening for the response. In such cases, the acoustic reflection/absorption/reverb profiles can provide information as to whether the floor is carpeted or hardwood, for instance. Light can be used to determine zones of effect, how rooms are connected, if windows are present (which could be used to more accurately predict/locate exterior walls), and the like, as further described above. By cycling individual lights on and off and monitoring light sensors on other host units, the area of effect for a particular light can be determined. By way of example, a hallway light may affect the luminance in the hallway by 100%, but may also affect the luminance of the living room by 40% (relative to the hallway) and a bedroom by 10%. This information can also be used to identify if rooms are connected by doors or openings. If a light that has a known effect in another room, but does not affect the other room all the time, it may be determined and incorporated into the floor plan that there is a doorway between them, as described in a similar scenario addressed above. In addition, if the light sources that affect a room are turned off and there is still light detected, it may be determined that there is a window in that room. By looking at the relative brightness measurements of each sensor, you can then determine which wall the window is located. Furthermore, some aspects may be repurposed or have multiple uses. The UWB sensors (or LIDAR, ultrasonics, etc.), for example, may be used to not only generate a floor plan, but may also operate as a presence detect system. If a distance measurement (communication) between two host units is interrupted by a user walking through a room, and then communication between another set of host units in the room are interrupted, then not only can a presence be detected, but also a trajectory and, in some cases, a predicted destination based on the user's determined travel vector, the time of day, the user's calendar, a user's habits, etc. For instance, the user may have an appointment in 10 minutes and based on the presence detection described above, it may be determined that the user is heading to the garage. In such a scenario, the overall system may turn on lights along the way to the garage, open the garage, communicate with and start the user's vehicle, or other useful prognosticative action. There are myriad possibilities and one of ordinary skill in the art with the benefit of this disclosure would understand the many variations, modifications, and alternative embodiments thereof.

In further embodiments, the Module ID of reported devices installed in a room can be used to determine the use of the room. For instance, a refrigerator is likely to be located in the kitchen, the humidity sensor is likely to be located in the bathroom or by the air conditioner, a baby monitor is likely to be located in a nursery or in the master bedroom. One of ordinary skill in the art with the benefit of this disclosure would understand the many variations, modifications, and alternative embodiments thereof.

FIG. 10 shows a typical configuration of a plurality of a modular accessories, host units, and a brain, according to certain embodiments. Each modular accessory 1010, 1020 can be coupled to a corresponding host units 1030, 1040 via a DC UART connection for auto bootstrapping procedures (e.g., see FIG. 6), AC power, and data transmission lines (e.g., fiber optic lines) that may extend to the brain 1050. Host units 1030, 1040 may be in communication with one another (e.g., for ranging) and in wireless communication (e.g., Wi-Fi, Bluetooth, BLE, ZigBee, Z-Wave, IR, RF, etc.) with brain 1050.

FIGS. 11A-11C show a number of possible node, aggregator, brain network configurations, according to certain embodiments. A node may refer to an end point that generates 1^{st} order data (e.g., raw sensor readings, event detection) or takes an action. For instance, a node can be a host unitmodular accessory pair. An aggregator can collect 1^{st} order data from nodes, generate 2^{nd} order data, (e.g., event classification, event grouping and summary)and can distribute 1^{st} and 2^{nd} order data. A brain can be configured to collect 1^{st} and 2^{nd} order data, generate 3^{rd} order data (e.g., event categorization and identification, and context aware event grouping and summary) and issue directives to node(s) and aggregator(s), such as take an action, update a logic table, update a network configuration, or the like. The logic table may store what actions the modular accessory can take and what inputs are required to make those decisions. The table can be generated by the brain and pushed to the modular accessory, with updates occurring the same way. Referring back to the figures, FIG. 11A shows a network configuration including a node, aggregator, and brain topology, FIG. 11B shows a network configuration including a node and aggregator topology, and FIG. 11C shows a network configuration including a node and brain topology. In some embodiments, a brain can be implemented on a general purpose computing device such as a desktop computer, laptop computer, tablet computer, smart phone, smart wearable, other handheld or wearable computing device, or the like, by providing the general purpose computing device with appropriate executable program code; alternatively, a controller can be a special purpose computing device. By way of example, FIG. 12 shows a simplified flow chart of a typical node, aggregator, brain interaction, according to certain embodiments.

FIG. 13 shows a simplified flow chart for automatically generating a floor plan and provisioning a modular accessory, according to certain embodiments. Method 1300 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 1300 can be performed by a brain or equivalent, host unit, modular accessory, or any combination thereof.

At block 1310, method 1300 can include establishing an electronic communication between a host unit and one or more additional host units in the building, wherein the host unit is embedded within a support structure of a building.

At block 1320, method 1300 can include determining a distance from the host unit to the one or more additional host units based on the electronic communication between the host unit and the one or more additional host units. In some cases, determining the distance may be performed using one of ultra-wide band (UWB) communication, radar, ultrasonics, or IEEE 802 communication protocols.

At block 1330, method 1300 can include receiving orientation data from the host unit and the one or more additional host units and determining a physical orientation of the host unit and the one or more additional host units based on the orientation data. In such cases, generating a floor plan for the building may be further based on the determined physical orientations of the host unit and the determined physical orientations one or more additional host units. Each of the host unit and the one or more additional host units may include a magnetometer operating as a compass and an accelerometer configured to detect an orientation of the host unit relative to a direction provided by the magnetometer, where the orientation data may include the data received from the magnetometer and the accelerometer. Alternatively or additionally, a phased antenna array can be used to determine angle of arrival of communication data between host units, as discussed above with respect to FIG. 4.

At block 1340, method 1300 can include generating a floor plan for the building based on the determined distance(s) from the host unit to the one or more additional host units.

At block 1350, method 1300 can include receiving and housing, by the host unit, a modular accessory, where the host unit can be coupled to an electrical source and couples electrical power from the electrical source to the modular accessory in response to the modular accessory being received and housed by the host unit.

At block 1360, method 1300 can include providing bootstrap capabilities to a coupled modular accessory. As described above, a DC UART connection may provide DC power and limited resources to allow a modular accessory to authenticate and identify itself (1370). In some cases, once authenticated, the installation of the modular accessory may need to be authorized (e.g., approved by a user).

At block 1380, in response to the authorization of the modular accessory, method 1300 can include gating the electrical power (e.g., AC and/or DC power) from the electrical source to the modular accessory by coupling the electrical power from the electrical source to the modular accessory in response to determining that the modular accessory is communicatively coupled to the host unit, and decoupling the electrical power from the electrical source to the modular accessory in response to determining that the modular accessory is communicatively decoupled to the host unit.

It should be appreciated that the specific steps illustrated in FIG. 13 provide a particular method 1300 for or automatically generating a floor plan and provisioning a modular accessory, according to certain embodiments. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof. Further, it should be noted that any of the methods described throughout this disclosure may be performed, for example, by a system having one or more non-transitory, computer readable storage mediums containing instructions configured to cause the one or more processors to perform operations of the method; or by a non-transitory computer-program product tangibly embodied in a machine-readable non-transitory storage medium including instructions to cause a processor to perform the operations of the method; either of which being embodied, for instance, by aspects of the system of FIGS. 4, 6, 10-12, 20. In some of the embodiments, one or more processors may perform the operations of method 1300, which can include processor(s) on the host unit, processors on a remote entity (e.g., a brain, laptop, smart device, etc.), processors on multiple host units, or any combination thereof, as would be appreciated by one of ordinary skill in the art with the benefit of this disclosure.

In some embodiments, a mobile electronic device (e.g., smart phone, remote control, smart wearable device, laptop, etc.) may be detected and the system may determine that the mobile electronic device is pointing at the host unit and control may be offloaded in whole or in part to the mobile electronic device to allow, for example, a smart phone to control certain functionality of the system (e.g., turn off the lights) by simply pointing at a particular modular accessory/host unit. Once it has been determined that a mobile electronic device has selected a host unit, it can control it either with via conventional means (e.g., buttons, menus) or by using the orientation data on the mobile electronic device to sense gestures to initiate control schemes.

### Object Detection Using a Mesh of Host Units as “Virtual Tripwires”

In some embodiments, a modular multi-host system may be configured to detect the presence of an object by measuring changes in distance measurements between host units. When an object obstructs a particular line-of-sight measurement between host units, the communication signal (e.g., UWB, ultrasonics, etc.) may pass through the object, which can change the TOF measurement. For instance, if a distance between two host units is measured to be 2.5 m via TOF calculations and a sofa is subsequently placed between the two host units, obstructing the line-of-sight between them, the measured distance may change as the UWB signals may pass through the sofa at a slightly slower rate than in open air. Changes may be on the order of millimeter, centimeters, or more, depending on the type of obstruction. As described above, the line-of-sight (LOS) communications between host units may be thought of as operating like virtual “trip wires” that “trigger” when an objects passes between them and changes their corresponding line-of-sight TOF measurement. In some cases, the computations to determine the distances between host units may be performed at the host unit(s), by installed modular accessories, by aggregators, by a system brain, or a combination thereof, as described above.

Alternatively or additionally, some embodiments may use phased antenna arrays in the host units to communicate with other host units in the system. In such systems, an angle-of-signal arrival for the phased antenna arrays can be measured. Objects passing through the line-of-site of the communication may distort or change the angle-of-signal arrival. Such changes may be used (e.g., threshold changes) to determine a presence of an object, as described above with respect to TOF distance measurements, as would be appreciated by one of ordinary skill in the art with the benefit of this disclosure.

In addition to a change in a measured distance, an amount of distortion in the measured signal, which can manifest as an amount of variation in a measured distance, can be used to determine a type of detected object. As briefly described above, some uniform and inert materials may cause a change in the TOF measurement (and consequently the measured distance) that is relatively constant, while other non-uniform materials (e.g., a human or pet) may be in constant change, resulting in a fluctuating TOF measurement, which may manifest as “noise” or distortion in the measured signal. The amount of distortion and the frequency content of the distortion in the TOF measurements can be used to help distinguish such objects. Alternatively or additionally, a phased antenna array in one or more host units may be used in a similar manner. That is, an amount of distortion and the frequency content of the distortion in the angle-of-signal arrival signals can be used to determine a type of detected object (e.g., animate vs. inanimate). In some embodiments, an average angle-of-signal arrival can be estimated and typically a delta of three sigma from the estimated average may trigger an event. In some cases, a change of 10 degrees or more may be a threshold to trigger object detection. Any delta or change in degrees (larger or smaller) can be used as a threshold trigger. In some implementations, multiple triggers can be used (e.g., with varying levels of confidence—the greater the delta/change, the greater confidence in object detection). One of ordinary skill in the art with the benefit of this disclosure would appreciate the many modifications, variations, and alternative embodiments thereof.

Host units configured for object detection may operate continuously or intermittently, synchronously (e.g., across multiple host units) or asynchronously, or other suitable configuration. For example, periodic measurements (e.g., every 10 ms, 100 ms, 1 s, 5 s, etc.) or aperiodic measurements are possible. In some cases, object detection (e.g., wireless communication between host units and TOF measurements) may be enabled when it is known that an occupant is in a building (e.g., via other sensor systems, communication with user mobile devices (e.g., smart phone or watch, or the like). The density of the object detection mesh may be based on user presence within the building. For instance, if there is no one in a particular room, object detection may only be enabled to cover the entrances of the room. When an object enters the room, the density can then be increased to give fine grained position within the room.

FIG. 14 shows aspects of object detection using a configurable home infrastructure, according to certain embodiments. In particular, three simplified scenarios are depicted and described to illustrate aspects of object detection and object type identification, as further described below. Note that any mesh of two or more host units can be used, however meshes with greater number of host units and virtual trip wires may tend to provide more data, greater resolution with respect to pinpointing an object's precise location, etc. For the purposes of explanation, the following embodiments will refer back to the host unit mesh of the configurable home infrastructure shown and described above with respect to FIG. 7.

Referring to FIG. 14, scenarios A-C depict a user 1410 pushing a couch 1420 along the floor and through a virtual tripwire formed by the LOC communication path between sensor 710(4) and sensor 710(2). In scenario A, couch 1420 is passing through the tripwire. In scenario B, user 1410 is passing through the tripwire. In scenario C, user 1410 finishes moving couch 1420 and stops to rest. Note that in scenarios A and B, couch 1420 and user 1410 are moving at the particular points in time that are shown. In contrast, the user is standing still with relatively no movement through the tripwire.

FIG. 15 is a simplified graph 1500 showing changes is distance measurements between host units as different objects are passed between them, according to certain embodiments. Graph 1500 shows a measured distance between sensors 710(4) and 710(2) for scenarios A-C depicted in FIG. 15. In scenario A, as couch 1420 begins passing through the tripwire, the TOF between sensors 710(4-2) the wireless communication signal may take more time to pass through the materials forming couch 1420, as compared to an unimpeded, open air transmission. Alternatively or additionally, the TOF may take an alternate path between the transmitting host unit and receiving host unit by way of reflections of the walls, ceiling, or other objects. In such cases, the system can measure any particular TOF (e.g., the first reflection) as a reference measurement. In any of these cases, the measured distance between sensors 710(4-2) may appear to be increased. Referring to graph 1500, section A, as couch 1420 begins traversing the tripwire, the TOF measurement increases, causing an increase in the distance measurement between host units from about 3 m to approximately 3.08 m. Note that the distance measurement prior to couch 1420 passing through the trip wire is relatively constant with a small amount distortion (e.g., variation) in the calculated distance. In scenario A, as couch 1420 passes through the tripwire, the increased distance measurement includes a small increase in distortion. As chair 1420 completely passes through the tripwire, the calculated distance between sensors 710(4-2) returns to 3 m with comparatively little distortion. As described above, couch 1420 may be comprised of uniform and/or inert materials, which can result in small amounts of distortion as compared to non-uniform and/or continuously changing objects, such as a person or animal. As described above, and as applied throughout the disclosure, both the magnitude (amount) and frequency content of the distortion changes may be used.

In scenario B, couch 1420 completely passes the tripwire and user 1410 begins passing through. Referring to graph 1500 section B, a large increase in the calculated distance between sensors 710(4-2) is shown as the material properties of user 1410 cause a greater change in the TOF measurement and greater distortion. As described above, user 1410 is comprised of organs, bones, flowing liquids, etc., with each having a different density and effect on the TOF measurement, hence the simplified representation of the changing measured distance over time showing how different portions of the body may affect the distance calculation. After user 1410 passes through, the calculated distance measurement between sensors 710(4-2) returns to about 3 m with minimal distortion.

In scenario C, user 1410 stops moving and remains stationary. After the initial change is calculated distance (similar to scenario B), the calculated distance is shown with significantly more distortion as compared to couch 1420. When user 1410 remains stationary, the peak may (hump) settle to an average value with significant distortion as compared to couch 1420 for the reasons described above. Note that the representation of the time scale and how changes in a calculated distance between sensors 710(4-2) is simplified for the purposes of explaining the concepts herein. It would be understood by one or ordinary skill in the art with the benefit of this disclosure that these signals may vary considerably, however the underlying concepts regarding changes of distances measurements and corresponding distortions still apply. Further, one of ordinary skill in the art with the benefit of this disclosure would understand that phased antenna arrays and angle-of-signal arrival (also referred to as “angle-of-arrival” or “AoA”) can be used instead of or in addition to TOF to detect a presence of an object (e.g., based on a threshold change), detect an amount of signal distortion or frequency shift in the AoA, or the like, as described above with respect to distance and TOF measurements.

FIG. 16 shows aspects of determining a vector for a detected object, according to certain embodiments. Referring to scene 1600, a user 1610 is moving across a room and traversing two virtual tripwires formed by host unit pairs 710(4-1) and 710 (4-2). The traversal across each tripwire generated by each host unit pair may cause the TOF and corresponding distance calculation to change and distort, as described above and as shown in FIG. 17. For instance, as user 1610 passes through host unit pair 710(4-1), a determined distance appears to increase (see Gaussian curve 710(1-4)), peak at 1702, and drop off thereafter as user 1610 moves past the tripwire. Similarly, as user 1610 passes through host unit pair 710(4-2), a determined distance appears to increase (see Gaussian curve 710(2-4)), peak at 1704, and drop off thereafter as user 1610 moves past the tripwire. The traversal over multiple tripwires necessarily occurs in a chronological fashion. As such, a user's travel vector can be determined based on the chronological order that the user passes the tripwires. In a simplified example, if a user passes two parallel tripwires at an angle normal to the tripwires, the user's vector can be calculated based on the distance between the two parallel tripwires in a direction normal to said tripwires. Typically, a denser mesh of tripwires can facilitate greater resolution and accuracy with location tracking and vector calculations. It should be noted that the distance measurement waveforms show one representation, however many other are possible, For example, some systems may have discontinuous measurements (e.g., measured every 100 ms), some communication mediums may be more or less impeded by objects, resulting in different TOF measurements and/or distance calculations. Although a simplified number of host pairs using a common host unit 410(4) is shown in FIGS. 16-17, vector measurements can be made between different sets tripwires that may not have a common host unit. One of ordinary skill in the art with the benefit of this disclosure would understand the many variations, modifications, and alternative embodiments thereof. Note that the use of the term “vector” used with respect to a detected object can mean a determined direction and rate of the object. This is not to be confused with the “normal vector” described above in FIG. 4 with respect to gravity for determining host unit orientation.

In some embodiments, a vector may be determined based on a trigger of a single virtual tripwire. For example, if a user is known to be present in a room and/or the object's dimensions are known, then an analysis of the transient response of the single Gaussian waveform can provide distance data, speed data, or both. In some cases, a single tripwire may partially rely on the angle of arrival (AoA) changing rather than just the ToF. For instance, consider a single tripwire with one node at the origin and the other some distance away. From the perspective of the origin node, as a user walks through the trip wire from left to right, the AoA from the far node may preferentially shift right (i.e., the far node appears to have moved to the right from where it was originally), then become occluded (dominant reflection path), then come back with a left shift (appear to the left of its original position) and finally return to normal. From the perspective of the far node, the user would appear to walk through the wire right to left, so the AoA shift may be reversed: shift left, occluded, shift right, normal. In the case of multiple tripwires, a simple example is between three nodes, one at the origin, a far left node and a far right node. If origin-left trips then origin-right trips, then the occluding object was passing on a trajectory from left to right from the perspective of the origin node. If origin-right trips then origin-left trips, then the occluding object was passing on a trajectory from right to left from the perspective of the origin node. In both of these methods, the rate of change or time-proximity of sequential occlusion can provide information as to the size and/or velocity of the object that is occluding the tripwires. Furthermore, the orientation of a user within the tripwire affects the distortion that is added to the measured distance. In addition, the width of the Gaussian can be used to detect how long a user is within the tripwire. These two aspects combined can be used to approximate the angle at which the user is moving relative to the tripwire. It should be noted that although the many examples provided herein present two or more host units of a modular home infrastructure as the primary implementation of generating virtual trip wires, it would be understood by one of ordinary skill in the art that the various ToF, AoA, distortion-based analysis, etc., could be implemented on other devices as well, including any set of devices with communications technology such as UWB, radar, ultrasound, RF, etc., as described above. For example, Apple HomePod® devices may be configured to generate virtual tripwires, as would be appreciated by one of ordinary skill in the art with the benefit of this disclosure.

FIG. 18 shows aspects of differentiating between multiple detected objects in a configurable home infrastructure, according to certain embodiments. In scenario A, user 1 and user 2 are walking in opposite directions toward each other in a mesh of virtual tripwires. For this example, it is assumed that the mesh of virtual tripwires is dense enough such that users 1 and 2 can be continuously tracked within the scene, as represented by the moving Gaussian curves of graph 1810 (denoted as A₁) that track a change as a determined distance between host units and, for the purposes of explanation, a position of the tracked object in the scene. In scenario B, user 1 and user 2 are crossing paths, which is represented in graph 1820 (denoted as B₁). In scenario C, it is unclear (from a system detection perspective) whether user 1 and user 2 have crossed paths and are continuing on their previous trajectory, or if they stopped and changed directions crossing paths, as represented in graph 1830 (denoted as C₁). It should be noted that this example is simplified to illustrate alternative ways to differentiate one detected object from another when their corresponding signals (e.g., based on TOF measurements) are momentarily ambiguous, as shown in graphs 1820 and 1830.

In some embodiments, a mesh of virtual tripwires in a particular area may provide three-dimensions of resolution (trigger points) when enough interconnected host units are located in a particular area, as shown in a simplified manner in scenario A. In such arrangements, users 1 and 2 can be differentiated from one another based on their physical attributes. For instance, a dense mesh of virtual trip wires may provide enough resolution to determine an object's relative size and movement characteristics. Some trip wires may be configured higher or lower than others, some may be directed at different angles relative to one another, etc., which can provide enough data points to determine an object's relative size and movement characteristics. For example, users 1 and 2 may be distinguished at scenario C if their heights are sufficiently different (e.g., five feet versus six feet tall) and enough tripwire resolution is available to recognize the different. In one instance, a trip wire may be configured at around six feet, such that user 1 traverses it, but user 2 does not. In another example, an object's vector can be used to differentiate from another object if their corresponding speeds/directions are sufficiently different and determinable. In some cases, a person's gate (characteristics of their walking pattern) may be detectable in certain meshes, which can be used to help differentiate between multiple users.

In some cases, biometrics can be used to differentiate users. Biometrics such as fingerprints, iris scans, etc., generally require a person to physically provide this information for a sufficient level of authenticity (versus a wirelessly sent digital representation of a biometric). A person's heart beat pattern may provide uniquely identifying traits of the person and can be measured remotely. Although a heart rate may change, certain characteristics of the heart beat pattern can remain regardless of the heart rate. For instance, a 60 GHz millimeter wave sensor (MWS) system (or MWS system operating at another frequency) may be used to scan a person's heart rate. In some cases, respiration rate can also be measured with this technique, and can be used to help differentiate users. Referring back to FIG. 18, user 1 can be differentiated form user 2 when tracking their heart rates (shown in the figure). The users may be differentiated based on the rate of the heartbeat and/or the pattern of the heartbeat, as described above. In some embodiments, a 60 GHz millimeter wave scanner (or other suitable heart rate scanning technology) may be incorporated as a modular accessory in one or more of the host units in a given mesh.

FIG. 19 is a simplified flow chart 1900 showing aspects of object detection, vector detection, and user authentication in a configurable home infrastructure, according to certain embodiments. Method 1900 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 1300 can be performed by a brain or equivalent, host unit, modular accessory, or any combination thereof

At step 1910, method 1900 can include establishing a wireless communication between a host unit and an additional host unit(s), according to certain embodiments. Any suitable wireless communication protocol can be used including, but not limited to, UWB, radar, ultrasound, RF, ZigBee®, Z-Wave®, IR, Bluetooth® and variants thereof, or the like).

At step 1920, method 1900 can include determining a distance from host unit to additional host unit(s) based on a TOF of the wireless communication signal. For example, the distance between host units can be derived from the time it takes (i.e., time of flight) for the communication signal (or data thereof) to be emitted from the first host device and detected by the second host device, as further described above at least with respect to FIGS. 7-13.

At step 1930, method 1900 can include detecting a presence of an object based on a change of a determined distance between a host unit and the additional host unit(s). An object that crosses the communication path (e.g., virtual tripwire) can cause a delay in the TOF, which can cause the calculated distance between host units to increase. The change in the TOF (or calculated distance, or both) can be used to identify a presence of an object between the host units. In some cases, a threshold value for the change may be used to determine when an object is present (e.g., threshold met) and when there may simply be some random interference or noise (e.g., threshold not met) but no object (e.g., caused by EMI, system glitch, etc.). As indicated above, AoA and variance of the measured ToF can be used, magnitude and frequency content of noise on the measure distance can be used, as well as other metrics, such as signal strength and phase angle differences between multiple antennas.

At optional step 1940, method 1900 can include determining a type of the detected object based on a distortion in the determined distance, according to certain embodiments. At 1950, when the amount of distortion is greater than a threshold value (e.g., immediate step change may typically be 15-25 cm, but then can settle into a long-term offset on the order of 5-10 cm), the detected objected may be determined to be an animate object, such as a human or animal (step 1952). As described above, a high amount of distortion may be indicative of a non-uniform, non-inert object, which can also include other objects, such as a filled water cooler or other dynamically changing object that can manifest as greater distortion levels. When the amount of distortion is less than a threshold value, the detected objected may be determined to be an inanimate object, such as a chair, TV, table, or other solid and/or inert material that does not substantially change its composition or configuration over time (step 1954).

At optional step 1960, method 1900 can include determining a vector for a detected object based on a chronological order of changes in calculated distances, according to certain embodiments. For instance, a first pair of host units may detect an object when a TOF measurement between them increases by a threshold amount (e.g., 10 ps-10 ns, although other ranges are possible). Alternatively or additionally, object detection may be based on changes to a calculated distance between the host units, which can be derived from the TOF measurement, as described above. A vector for the object can be deduced by analyzing the chronological order of the object detection between host unit pairs (e.g., the timing of the triggering of each tripwire), a distance between each trip wire, and a time it takes for the object to be detected at each subsequent set of host unit pairs, as described above with respect to FIGS. 16 and 17.

At optional step 1970, method 1900 can include receiving identification and authentication data for a detected object, according to certain embodiments. For instance, identification data can include biometric data (e.g., heart rate data, finger print data, iris data), physical data (e.g., size data, walking gate data, etc.), or other identifying information that can be used to identify the person. Authorization data can include passwords, cryptographic key, USB drive with said passwords/keys, or other form of authorization that indicates that the detected person has some level of authorization privileges, which may include access to certain areas, permission to interface with certain systems (e.g., security system, safe, etc.), or the like.

At step 1980, method 1900 can include assigning a confidence level to the identified object (person) based on the identification and/or authentication data. A confidence level can be a level of certainty that the detected person is who they purport to be, or who the identification and/or authentication data appears to indicate who the detected person is. In some cases, a hierarchy may be established, such that certain identification and/or authorization data may provide different types of permissions for the detected person. For instance, biometric data may establish a first confidence level for an identified person, while a cryptographic key may establish a second, higher confidence level for the identified person. Different confidence levels may be used to establish different levels of access for the identified person. For example, a detected person may have full access and all permissions granted provided that they can positively identify themselves (e.g., an owner of a home). If the detected person provides biometric data to the host unit system (e.g., such as the systems of FIGS. 11A-11C) by physically providing it (e.g., provide finger print) or wirelessly providing it (e.g., received from a smart phone or wearable, heart rate detection as described in FIG. 18, etc.), but fails to produce authentication data, then a first level of confidence may be attained, but not the second. A consequential example may be that the person may utilize all entertainment devices, appliances, and general security features in the home (e.g., locks, geo-fence settings, etc.), but may not have access to certain heightened security systems (e.g., safe, security video controls, saved files with secure data, etc.). Some embodiments may prioritize biometric data (or certain subsets thereof) over authentication data. One of ordinary skill in the art with the benefit of this disclosure would understand the many variations, modifications, and alternative embodiments thereof.

It should be appreciated that the specific steps illustrated in FIG. 19 provide a particular method 1900 for object detection, vector detection, and user authentication in a configurable home infrastructure, according to certain embodiments. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

### Deductive Floor Plan Generation

The various embodiments described above outline systems and methods for generating a floor plan using communication between host units to deduce a location, dimensions, or orientation (or a combination thereof) of one or more walls to define one or more rooms in a building. The floor plan may be accessed by a user (e.g., on a display device) and the user may define a type for each room, such as the living room, kitchen, bedroom(s), garage, closet(s), or the like, by manually selecting and setting said definitions. Alternatively or additionally, a system (e.g., system 2000) can be configured to deduce a type of one or more of the various rooms without any manual data entry based on certain detected activity within the building, and modify (update) the floor plan accordingly to include the determined type of room (see, e.g., FIG. 20). Detected activity can be determined based on certain inputs (e.g., sensors, power usage, etc.), as described at least with respect to FIG. 21. Although the embodiments that follow largely focus on the determination of rooms, other information can be determined from the detected activity (e.g., foot traffic, direction of sunlight, acoustic properties of the room(s), user locations and corresponding implementations of media, resources (e.g., lighting, HVAC, etc.), and the like), as would be appreciated by one of ordinary skill in the art with the benefit of this disclosure and as further described below at least with respect to FIGS. 23-24. The floor plan can be a digital floor plan while the floor plan is updated, generated, etc. However, the digital floor plan can be output in any desired format (e.g., on a display device, printed as a hard copy, saved as a soft copy on a non-transitory computer readable medium, etc.).

FIG. 20 shows a system 2000 configured to perform deductive floor plan generation, according to certain embodiments. System 2000 shows a generated floor plan 2001 showing a number of rooms including a living room 2030, kitchen 2040, a first bedroom 2050, and a second bedroom 2060. It should be understood that floor plans may include fewer or more rooms with different types of rooms (e.g., closet(s), garage, dining room, utility closet, etc.). Floor plan 2001 is based in part on the floor plan of FIG. 8 and further includes host units 810(1)-(15) and doors 2034, 2041, 2052, and 2062. Living room 2030 includes a display device (e.g., television, projector device, etc.), kitchen 2040 includes oven 2042, stove 2044, and refrigerator 2046.

A user 2002 can manually input information into floor plan 2001 using any suitable type of user interface to label rooms, objects, appliances, IoT devices, or any feature in floor plan 2001, as would be appreciated by one of ordinary skill in the art with the benefit of this disclosure. Some user interfaces can include a head-mounted display 2003 (e.g., for virtual or augmented reality), a laptop computer 2004, a smartphone 2005, a smart accessory (e.g., watch, glasses, etc.), smart home interface device 2007 (e.g., HomePod® or similar device), or any other input device that a user can manually input data (e.g., defining a room as a kitchen, living room, etc.; labeling doors, appliances, etc.) by physical means (e.g., touching a screen, pressing buttons, making gestures, speaking commands, etc.) or non-physical means. For instance, in some cases, “manually” inputting data does not necessarily have to include a user touching or physically contacting an input device. For example, a microphone can pick up audio commands (e.g., voice commands) or sounds (e.g., clapping, snapping, etc.) and/or a video camera may interpret visual cues (e.g., hand or body gestures, etc.). One of ordinary skill in the art with the benefit of this disclosure would appreciate the many modifications, variations, and alternative embodiments thereof.

Alternatively or additionally, aspects of system 2000 may be configured to determine a type of one or more of the various rooms without user input based on certain detected activity within the room/building, and modify the floor plan accordingly to include the determined type of rooms, objects, or other features deduced by said system 2000. System 2000 can include one or more processors 2010 with inputs including sensor(s) 2012, dimension data 2014, tracking data 2016, utility usage data 2018, and more, as further described below at least with respect to FIG. 21. Processor(s) 2010 may be embodied as a brain or equivalent, host unit, modular accessory, or any combination thereof, as at least described above with respect to FIGS. 6 and 10-12. It should be understood that the term “sensor” data, at least with respect to FIGS. 20-26 may include data from sensor devices (e.g., microphones, video cameras, host unit devices (e.g., virtual trip wire data, accelerometer data, etc.) or the like) or from objects and/or sources not necessarily conventionally referred to as “sensors” such as power data from one or more appliances (e.g., “sensed” power from said appliances), conductive electromagnetic interference (e.g., “sensed” emissions from smart devices/accessories), or other sources, as further described below. That is, sensor data can include any suitable source of data can be used to help determine a type of room in the systems described herein, as would be appreciated by one of ordinary skill in the art with the benefit of this disclosure.

FIG. 21 shows a number of sources of input data that can be used by a system 2100 for deductive floor plan generation (e.g., determining a type of room), according to certain embodiments. The input data may include “sensor” data, which may include data from one or more devices that may conventionally be associated with “sensors” (e.g., audio, video, accelerometer, etc.) or data (which may be referred to as “sensor data”) that may not provide sensing data per se, such as power usage data and other sources, as further described below. System 2100 may be similar (e.g., similar number of system blocks, functionality, etc.) to the systems described above at least with respect to FIGS. 6, FIGS. 10-12, and FIG. 20.

Processor(s) 2110 can include one or more microcontrollers (MCUs) and can be configured to control the operation of system 2100. Alternatively or additionally, processor(s) 2110 may include one or more microprocessors (μCs), digital signal processors (DSPs), or the like, with supporting hardware, firmware (e.g., memory, programmable I/Os, etc.), and/or software, as would be appreciated by one of ordinary skill in the art. Alternatively, MCUs, μCs, DSPs, and the like, may be configured in other system blocks as described throughout this disclosure. Processor(s) 2110 can be configured to receive the various inputs (e.g., 2012-2018) and determine a type of one or more rooms in a building, determine a presence, location, orientation, functional aspects, or the like, of certain appliances or other objects within the one or more rooms, as further described below. Processor(s) 2010 may be embodied as a brain or equivalent, host unit, modular accessory, or any combination thereof

Sensor data 2020 can be used to help deduce a type of room in a floor plan, according to certain embodiments. Sensor(s) 2120 can include any type of data from a sensing device, according to certain embodiments. For example, sensor data can be received from sensors coupled to host devices and/or modular devices, as described above at least with respect to FIGS. 2A-5E and FIGS. 14-18. For instance, sensors can include video cameras (e.g., image data, video data), microphones (e.g., audio data), light sensors, motion sensors, vibration sensors (e.g., accelerometers sensing vibration in walls, vibrations due to certain appliances, such as a washing machine and dryer), or the like. Alternatively or additionally, sensors data can be received from sensor that are not necessarily coupled to the host unitsmodular accessories described above. For example, a security camera (not controlled by or coupled to a host unit) may provide image and/or audio data to processors 2110.

Processor(s) 2110 may determine a type of room based on sensor data in a number of ways. For example, image data may capture a significant amount of user traffic (e.g., users walking through the room or spending a lot of time in the room). Rooms with a lot of traffic and a lot of different users (particularly those with multiple users at one time) may more likely correspond to a public room, such as a living room or kitchen, rather than rooms that are likely subject to less user traffic, such as closets, bedrooms, and bathrooms. Audio data may pick up multiple users talking (again, a more social environment), media sources (e.g., television, radio), or other sounds (e.g., doorbell, knocks on the door, sound of sliding doors, sink/toilet/shower usage, appliance usage (e.g., microwave oven, hair dryer, etc.), which can be used to deduce a type of room. For instance, a living room may more likely be associated with multiple users, media, and a doorbell, while a bathroom may more likely be associated with sounds of water.

Other types of sensors may be incorporated, as would be appreciated by one of ordinary skill in the art with the benefit of this disclosure. For instance, the size of a room can be helpful in deducing its type, with a bathroom typically being smaller than a bedroom or living room. Sensors using RADAR, LiDAR, image sensors, cameras, etc., can help with room sizing, including the integrated ranging (e.g., UWB) in the host unit communication systems as described above. In a kitchen, for example, a variable temperature of a stove, toaster oven, etc., may be detected with a temperature sensor, an IR camera, or the like. Sensors configured to detect humidity (e.g., due to boiling water or hot water from a shower) and/or VOCs can help determine a room type as a kitchen or bathroom. Detected increases in temperature during certain times of the day/night may be used to deduce a type of room. For example, increased temperature (e.g., measured by a thermometer or IR sensor) and/or increased carbon dioxide (e.g., measured by a CO₂ sensor) in certain rooms at night may imply a bedroom as people and/or pets (that radiate body heat) may congregate in bedrooms at night. In some cases, ALS showing dynamic content form a nearby TV may be used to determine a living room space. Any suitable sensor array and combination thereof can be used, as would be appreciated by one of ordinary skill in the art with the benefit of this disclosure.

Dimension data 2130 can be used to deduce a type of room in a floor plan, according to certain embodiments. Dimension data 2130 can be determine by the system using the floor plan generation techniques described above. Alternatively or additionally, dimension data may be provided by a user or other resource (e.g., from city planning website with blueprints of the building). Dimension data 2130 can include the location of one or more walls within the rooms of the building, the dimensions of the walls (e.g., height, width, thickness), the location and/or dimensions of other objects in the building (e.g., sofas, tables, etc.), or the like. In some cases, the dimensions of the rooms (which may be determined based on the location/dimensions of the walls) can inform a type of room in a number of ways. For example, very small rooms may be more likely to be bathroom or closet, and comparatively large rooms may be more likely to be a living room or dining room. Locations of certain rooms can be helpful to determine a type of adjacent rooms. For instance, a garage (e.g., determined by its location at the front of the house, the presence of an automobile, etc.) may more likely be configured adjacent to a living room, kitchen, or utility room, rather than a bedroom or bathroom.

Tracking data 2140 can be used to deduce a type of room in a floor plan, according to certain embodiments. Tracking data can include virtual tripwire data (see, e.g., description of FIGS. 14-16), heart rate data (see, e.g., description of FIG. 18), traffic data, and wearable detection data. Traffic data can include detected movement of users throughout the building, which can be detected via virtual trip wires (e.g., UWB-based detection), image data, audio data, accelerometer data (e.g., vibrations), etc. Additionally, traffic data can be used to determined how many people use a room, how the room is used (e.g., a user is stationary for long periods during the night (possibly a bedroom), a user is active in the room during the day (possibly a living room), the room is mostly inactive (possibly a guest bedroom), etc.). Traffic data may include both movement and lack of movement (e.g., time spent in a particular room). Wearable detection data may be detecting conductive electromagnetic interference. In some cases, conducted EMI can be used to identify object that are touched when someone is wearing an appropriately enabled device (e.g., a smart watch). The signal may be detected on contact, which can be used to tag a location of object. Conduction may occur via wires as well, so an outlet can sense what is plugged into it. In some embodiments, EMI sensing can be used as another vector for sensing what devices are inside of a room. For example, each device can have a characteristic EMI signature that it radiates into the environment. Sensors can be configured to identify object in the space and perform location determinations (e.g., often with +/−1-3 meter resolution, although other ranges are possible).

Utility usage data 2150 can be used to deduce a type of room in a floor plan, according to certain embodiments. Utility usage data 2150 can include power profile data, which may correspond to how an appliance or other powered device utilizes power from a utility or other power source (e.g., solar system). For example, washers/dryers may have particular power usage curves. Toasters and ovens may have power usage curves that are indicative of their particular use. The motor of a washing machine and/or dryer may generate a characteristic, periodic power draw that may be used to both identify the washing machine/dryer and determine a room (typically, there appliances are placed in smaller rooms). In some cases, AC/DC power conversion wall units for electronic devices can have a characteristic power draw profile (e.g., idle versus charging) that can be detected and used to determine a room (e.g., a charger may be more likely to be in a room where people congregate). Televisions may have a different power draw profile than other appliances, which may also partially depend on content (e.g., pixel content, brightness, etc.). Appliance AC/DC circuits may have characteristic qualities as well, which can differ based on the type of appliance (e.g., televisions vs. toasters vs. oscillating fans). In some cases, furnaces and fans have characteristic motor signals with different operating frequencies than other appliances (e.g., washing machine). In addition, power frequency, power factor, inductive and/or reactive loads, or the like, can be used to determine to presence of particular appliances or electronic devices. As such, determining that an appliance indicative of an oven is in a particular room can be used to narrow the likely type of room to a kitchen. Any type of electronic input other than those expressly provided can be used, as would be appreciated by one of ordinary skill in the art with the benefit of this disclosure.

FIG. 22 is a simplified flow chart showing aspects of a method 2200 for generating and/or modifying a floor plan, according to certain embodiments. Method 2200 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 2200 can be performed by a brain or equivalent as described herein, a host unit, modular accessory, or any combination thereof

At operation 2210, method 2200 can include receiving digital floor plan data corresponding to at least one of a location, dimensions, and orientation of one or more walls defining at least one room of a building, according to certain embodiments.

At operation 2220, method 2200 can include receiving sensor data corresponding to detected activity within the at least one room of the building, according to certain embodiments.

At operation 2230, method 2200 can include determining a type of the at least one room of the building based on the detected activity, according to certain embodiments.

At operation 2240, method 2200 can include modifying the digital floor plan to include the determined type of the at least one of the one or more rooms, the digital floor plan operable to be output on a display device, according to certain embodiments.

At operation 2250, method 2200 can include displaying the modified digital floor plan on a display device, according to certain embodiments.

It should be appreciated that the specific steps illustrated in FIG. 22 provide a particular method 2200 for generating and/or modifying a digital floor plan, according to certain embodiments. Other sequences of steps may also be performed according to alternative embodiments. Furthermore, additional steps may be added or removed depending on the particular applications. For example, some embodiments may include determining an area of the at least one room of the building, where determining the type of the at least one room is further based on the area of the at least one room. To illustrate, a comparatively larger room (compared to other rooms in the building) may be indicative of a living room or other common living space, while comparatively smaller rooms may be indicative of a bathroom, closet, utility room, or the like. In some cases, the digital floor plan may include a plurality of rooms, where determining the type of the at least one room is further based on the location of the one room relative to locations of the remaining plurality of rooms. For example, a room adjacent to a second room that is determined to be a kitchen may be less likely to be a bathroom or bedroom and more likely to be a living room, dining room, or the like, based on conventional home designs. In another example, a room determined to be a garage may make adjacent rooms unlikely to be a bedroom. In some cases, rooms in the front of the home (e.g., street facing) may be more likely to be a garage than rooms in the back of the home (e.g., near the backyard). One of ordinary skill in the art with the benefit of this disclosure would appreciate the many modifications, variations, and alternative embodiments thereof.

Some embodiments may include additional method operations in method 2200 that include tracking a movement of an object in the one or more rooms, where determining the type of the at least one of the one or more rooms is further based on at least one of (1) an amount of time the object has spent in the one or more rooms, the amount of time based on the tracked movement of the object; and (2) a traffic pattern of the object in the one or more rooms, the traffic pattern of the object based on the tracked movement of the object. For instance, rooms that have multiple users simultaneously using the space may be more likely to be a common room, such as a living room, kitchen, dining room, or the like. Rooms with users that are stationary for long periods of time (e.g., 6-8 hours during the night) may more likely be a bedroom and less likely to be a kitchen or bathroom.

In further embodiments, the sensor data may include electromagnetic interference (EMI) data, where method 2200 can further include one or more of determining a type of the object based on the EMI data, and tracking a movement of an object in the one or more rooms. In such cases, determining the type of the at least one of the one or more rooms can be further based on at least one of an amount of time the object has spent in the one or more rooms, the amount of time based on the tracked movement of the object and a traffic pattern of the object in the one or more rooms, the traffic pattern of the object based on the tracked movement of the object. The EMI data may be from a smart device (e.g., smart phone, smart watch, etc.) or the like, which may have unique digital identifier data (“unique ID”) or other identifying data associated with it.

In certain embodiments, the digital floor plan data may include a location of a powered appliance within the at least one room of the building where the sensor data includes power data from the powered appliance, and determining the type of the at least one room of the building is further based on the power data of the powered appliance. In such cases, the power data may include at least one of: a power usage profile; a power frequency profile; a power factor; and characteristics of certain inductive or reactive loads. For instance, detecting a washing machine plugged into an outlet may be used to identify what is likely a laundry room or garage. Power tools may be more likely be operating in a shop or garage. A gaming system may be more likely operating in a living room, family room, or den. More examples are provided above. Displaying the modified digital floor plan data on a display device may also include displaying a visual representation of the floor plan data (not the floor plan data itself), or other suitable representation (e.g., data stored in a table or other database), which may or may not be presented to a user on a display device (e.g., tablet computer, laptop computer, smart wearable, television, etc.). One of ordinary skill in the art with the benefit of this disclosure would appreciate the many modifications, variations, and alternative embodiments thereof.

In yet further embodiments, the digital floor plan data may include a location of a host unit (or multiple host units and/or modular accessories) disposed within one of the one or more walls. In such cases, the sensor data can include accelerometer data from the host unit that can provide data corresponding to vibrations within the wall that the host unit is disposed in and/or is adjacent to. In some cases, vibrations can propagate through multiple walls, so some rooms can be determined based on a relative strength of the vibrations. For example, strong vibrations may correspond to a room with a washer and dryer. The same vibrations may be detected in adjacent rooms, but with a smaller amplitude (e.g., strength) signal. In such cases, determining the type of the at least one room of the building can be further based on characteristics and a location of the detected vibrations. Any combination of the above examples are possible as well as any other methods of deducing a floor plan and type of rooms, objects, etc., therein that would be contemplated by one of ordinary skill in the art with the benefit of this disclosure. That is, one of ordinary skill in the art with the benefit of this disclosure would appreciate the many modifications, variations, and alternative embodiments thereof

### Automated Guidance

In some embodiments, automated guidance can be provided to a user by a system (e.g., systems 2000, 2100) based on a knowledge of the digital floor plan, according to certain embodiments. “Guidance” can be provided in many different forms. For example, the system may provide guidance on how to install a security camera system based on the detected layout of the floor plan. Based on a known location of a living room, bedrooms, kitchen, doorways, entry ways, etc., certain locations and orientations of security cameras can be suggested to provide a preferred installation configuration to capture certain sensitive locations (e.g., entry ways, safe rooms, etc.), increase coverage of a field-of-view (e.g., capture multiple rooms, larger areas, etc., based on good camera placement), and the like. This is possible because the system, when aware of each room, their corresponding areas, and field-of-view (FOV) of the camera, can calculate (e.g., via processor(s) 2110) effective placement locations.

In another example, knowing the dimensions of the room (and to some degree the objects that inside it, like sofas, chairs, etc.), some systems may guide a user by identifying one or more locations on the digital floor plan to place speakers that can improve an acoustical response of the sound system or even reduce floor and/or wall vibrations per a renter's agreement or city ordinance. For instance, room acoustics may be determined based on room dimensions, wall heights, room shape, acoustic reflections, etc., which all can be determine based on the various sensors described above (e.g., microphones, dimension data, media system capabilities, or the like). In some cases, the system may incorporate active real-time noise cancellation for a user based on a detected location of the user, a known floor plan of the corresponding room, and a known location of one or more speaker elements within the room, as would be appreciated by one of ordinary skill in the art with the benefit of this disclosure. In another embodiment, a system 2000 may be configured to detect ambient light in one or more rooms via one or more image sensors (e.g., video camera configured as a modular accessory). Thus, at certain times of the day system 2000 may close window blinds to reduce glare on a television, or may alter one or more lighting elements to adjust for changing ambient lighting conditions.

Such embodiments may support the use of abstracted user instructions, which is made possible at least in part by the generated floor plan. For instance, a user may simply say “Reduce TV glare.” In response, the system may determine a location of light sources in the room (e.g., via image sensors), determine a location of the user (e.g., via virtual trip wires, microphone(s), image sensors, conductive EMI, etc.), determine a location of the television (e.g., via image sensors, microphone(s), power profile, etc.) and identify light sources that are the cause of the television glare (e.g., image sensors, known locations of light sources from the floor plan, etc.). In such cases, the system may close the shades, turn off or reduce lights that are located in an area (e.g., behind the user and in front of the television) that may contribute to television glare, and configure lighting (e.g., change color, intensity, etc.) that can reduce television glare (e.g., lights behind the television). Conventional systems would be unlikely to perform these tasks as it takes into account real-time inputs including a location of a user and adjusts according to potentially unique conditions each time. For instance, a user sitting directly in front of a television would likely have different lighting conditions to reduce glare than a person watching from a different angle. The systems described herein can accommodate for such conditions in real-time for a single user, multiple users, etc., for a contextually aware solution to a request. Further, system generated solutions do not require the identification of specific devices. The user does not need to identify which television, lights, or sounds as the system can track the user's location, contextually determine which television is likely viewing, analyze the ambient light conditions relative to the television and user, and make corresponding adjustments to achieve the requested result. Thus, the same command made in a different room can also achieve the same outcome (e.g., reduce the glare), but would likely achieve that outcome in a different manner given the likely different room dimensions, acoustics, lighting conditions, and the like. An example of this contextual response to a user request is described below with respect to FIG. 23.

Another example of a contextual response to an abstracted request can include changing operational parameters in real-time. For example, if a user was watching a sports channel in the living room and walks into the kitchen, the system may route the audio from a stereo system in the living room to speakers in the kitchen so that the user can still listen to the sports coverage despite not seeing the video. An example of this is shown below with respect to FIG. 24. In another scenario, if the user is watching a movie and walks towards the bathroom (e.g., as detected by virtual tripwires), the system may pause the movie, turn up the lights including a lighted path to the bathroom, and await the user's return before continuing playback of the movie. In some embodiments, contextual decisions can be modified by user preferences and/or system preferences. For instance, a user may indicate playback options for movies, sports media, music, preferred lighting conditions for a particular setting (media or otherwise), and the like, and the system will contextually respond to a request under the framework defined by the user/system preferences. In each case, the system can be contextually aware of the appropriate course of actions based on the context where the request is made, as described in the examples above. Preferences can be associated with particular users, rooms, or a combination thereof. User preferences may have hierarchically defined to give certain users priority over others. For instance, the system may play media according to a first user with a higher priority than a second user, despite both the first and second user being present at the same time.

FIG. 23 is a simplified diagram showing a scene 2300 with a system configured to modify media accessories and lighting for a user based on their detected location, according to certain embodiments. Scene 2300 includes living room 2030 with user 2305 seated on a chair and viewing display device 2320. Audio system 2330 can include surround sound speakers (1)-(4). The system further includes light sources 2340(1)-(3) and window shades (e.g., blinds) 2350. The scene 2300 may utilize system 2000, which can incorporate aspects of the systems of FIGS. 6-19, as described above. Referring to FIG. 23, system 2000 identifies user 2305 via any suitable method including, but not limited to, image sensing, device unique ID tracking, audio detection, virtual tripwires, heartbeat monitoring, or the like. User 2305 is watching display device 2320 and system 2000 may configure the audio system to perform three-dimensional auto-location, such that the audio output by surround sound speakers 2330(1)-(4) are directionally configured to improve audio acoustics at the location of user 2305, which may change in real-time as user 2305 moves throughout room 2030. Light sources 2340(1)-(3) may be set to minimize glare at user 2305′s location and, in some cases, change a lighting scheme per user 2305 preferences.

FIG. 24 is a simplified diagram showing a transition of media and lighting as a user transitions from first room to a second room, according to certain embodiments. As user 2405 moves from living room 2030 to kitchen 2040, system 2000 contextually updates video, audio, and lighting settings so accommodate the user's surroundings. For instance, kitchen 2040 may have audio and lighting capabilities, but no video devices. System 2000 may transfer the audio (e.g., per user and/or system preferences) to speakers 2430(1)-(2) based on a type of media. For example, sports programs and music, for instance, may be transferred throughout the home, while movies may be paused when the user leaves, receives a phone call, or the like. One of ordinary skill in the art with the benefit of this disclosure would appreciate the many modifications, variations, and alternative embodiments thereof.

### Remote Control for Use in Certain Embodiments

In some aspects, a remote control can be used to contextually control media, appliances, IoT devices, etc., throughout the one or more rooms by pointing the remote control at a target device and sending a command. In conventional remote control devices, remote controls are often paired with the various devices that they are configured to control, which typically requires a setup process. Aspects of the invention may include a remote control that can control any device, appliance, or system in a home without any pairing procedures or association with the particular device being controlled. This is possible due to a combination of the digital floor plan of a structure (e.g., building) and a dead reckoning system that allows the remote control to know its orientation in 3D space within the structure. Thus, the system determines which direction the remote control is pointing, determines what device(s) the remote control is pointing at, determines what functions are being input to the remote control, and contextually controls the device(s) that the remote control is pointing to based on the input to the remote control and the functional/operational capabilities of the device(s). For example, a user may point the remote control towards a first media device (e.g., a television). The system and/or the remote control determines that the remote control is pointing towards the direction of the television by way of the dead reckoning system on the remote control, and the system knows that the television is located in that directions by way of the digital floor plan. If the user presses a button, for example, while pointing at the television, a paused televised program may start playing. However, if the same button is pressed while the remote control is pointing at a light source (e.g., the light source being included in the digital floor plan), the light may toggle its power. Although the embodiments described herein primarily discuss a remote control device, other implementations of the remote control are possible including adaptation of a mobile device (e.g., smart phone, watch, etc.) or other mobile, user controllable interface, as would be appreciated by one of ordinary skill in the art with the benefit of this disclosure.

In some embodiments, media may be accessed by the remote control and the user may “flick” or move the remote control towards a media device to transfer the media to that device. For instance, in an example, a user may be listening to a sports game on a radio. The user may select the radio by pointing the remote control to the radio and then gesturing from the radio to a television in order to move the content to the television. A media system may then find the sports game on a particular channel and configure the television to play that channel. This all can be performed because the remote can provide information corresponding to its direction and the underlying system (2000) knows where the corresponding devices are located. As such, there may not be a direct communication between the remote control and the media device (e.g., television or audio system), as in conventional devices, but a communication with system 2000 to indicate that a function has been entered by a user on the remote control and a direction or gesture entered via a user interface on the remote control, which can be used to determine how the function is implement. In the example above, the function can be to transfer currently played content from an audio device to a display device, as described above.

FIG. 25 shows a remote control 2500 configured to control media and route control signals to various appliances, media, accessories, and environmental controls, according to certain embodiments. Remote control 2500 can include a housing 2505 with input elements 2510 and 2520 disposed thereon. Input element 2510 may be a multi-button selection switch, as shown, or any other suitable input element including a touch sensitive touch sensor, touch sensitive display, buttons, switches, or the like. Input element 2520 can include a touch sensitive, depressible button to allow a user to input data. Remote control 2500 can be sized to be hand-held by a user and may include one or more processors (e.g., micro-controller, processor, ASIC, etc.); a input/output module controlled by the processor(s) and configured to control input (user inputs including button presses, touch screen controller inputs, etc.) and output (e.g., display, control signals, etc.) functions; a communications module to facilitate communication of the remote control with other devices (e.g., Bluetooth® radio, IR blaster, UWB, etc.), system 2000 (or other systems described herein), or a combination thereof, memory storage element(s); a dead reckoning system (e.g., IMU based, UWB, a combination thereof, etc.) configured to determine the remote control's orientation within (which can be used by system 2000 to determine what remote control 2500 is pointing at, how it is oriented, etc.), and the like. In some embodiments, remote 2500 may include some or all aspects of system 2700 described below.

In certain particular embodiments, remote 2500 can support enhanced TV navigation, text input, gaming, and more. Remote control 2500 may include two recessed touch pads (with an integrated button) that can operate as the universal buttons for interacting with one or more media systems, modular multi-host systems (as described above), or the like, or a combination thereof. In some implementations, remote control 2500 may have a symmetric configuration that reorients the controls depending on which end is facing a device currently being controlled (e.g., the television). Remote control 2500 may be turned sideways and operate in a gaming and text entry mode, for example. In gaming mode, the two touchpad can operate as either as a joystick or a button pad. For text entry mode, each touchpad may control half of the keyboard. Controls for media control mode (e.g., a TV mode) may be pushed towards a gestural system, where for example a button press and hold on a touchpad can cause a marking menu at the bottom of the TV to be generated. To select an option, a user can swipe in the desired direction and release the button. To indicate which direction the swipe is headed, the selected menu item may pop up on the controlled device. One of ordinary skill in the art with the benefit of this disclosure would appreciate the many modifications, variations, and alternative embodiments thereof.

Alternatively or additionally, some user interface (UI) elements on the remote control (e.g., home, play/pause, volume) could be hidden elements on the touchpad that are revealed by a backlight when the user picks up remote control 2500. The UI elements may reorient when remote control 2500 is picked up such that the UI elements are aligned with a particular viewing angle with respect to the user. Controls can be symmetric (e.g., both touchpads have similar controls), where the forward set (the set away from the user) illuminates, or there could be two different sets of buttons (e.g., top has home, play, Siri®, etc., while bottom has volume control, forward, back, etc.). In the symmetric case, volume and forward/reverse may be controlled by pushing the icon and then moving their finger clock-wise or counter-clock-wise. In the asymmetric case, Play/Pause, Menu, etc. can be on the far touchpad, and icons for volume up, volume down, forward, and back may appear appear on the near touchpad. In some implementations, remote control 2500 could support more complicated gaming controls by having a game controller accessory that the remote clicks into. This may provide a more ergonomic experience as well as advanced functionality, including an analog joystick, start/menu buttons, shoulder bumpers, and the like. This could be enabled by, for example, adding an Orion® connector to the side of the remote.

FIGS. 26A-B show a remote control directing media in a scene 2600 to a number of media accessories based on a directional movement of the remote control, according to certain embodiments. Scene 2600 includes a remote control 2610, a display device 2620, and an audio device 2630. FIGS. 26A-B show how content can be “flicked” or moved to or between devices via remote control 2610. FIG. 25A shows how a user can select media and gesture toward display device 2610 to play media content thereon, which may include both video and audio content. Alternatively, the user may gesture toward audio device 2630 to play the media content, as shown in FIG. 25B. The gesture may be a performed on a touch sensitive input (e.g., a touch pad on the remote control) or can be a movement to point the remote control to the desired device to play the media content. As described above, a system (e.g., system 2000) that is aware of a location of the various electronic devices in a location (e.g., home, building, area, etc.) can determine what the remote control is pointing at via its orientation (dead reckoning) capabilities and determine a function based on the requested action (e.g., play media content) and the device being selected (e.g., play audio on the audio device 2630). This is but one example of the myriad possibilities and implementations, as would be appreciated by one of ordinary skill in the art with the benefit of this disclosure.

### Example of a System for Operating Controller Devices in a Host Unit Network

FIG. 27 shows a system 2700 for operating a controller devices (brain) in a host unit-modular accessory network, according to certain embodiments. System 2700 can be used to implement any of the host controller devices discussed herein and the myriad embodiments defined herein or within the purview of this disclosure but not necessarily explicitly described. System 2700 can include one or more processors 2702 that can communicate with a number of peripheral devices (e.g., input devices) via a bus subsystem 2704. These peripheral devices can include storage subsystem 2706 (comprising memory subsystem 2708 and file storage subsystem 2710), user interface input devices 2714, user interface output devices 2716, and network interface subsystem 2712. User input devices 2714 can be any of the input device types described herein (e.g., keyboard, computer mouse, remote control, etc.). User output devices 2716 can be a display of any type, including computer monitors, displays on handheld devices (e.g., smart phones, gaming systems), or the like, as would be understood by one of ordinary skill in the art. Alternatively or additionally, a display may include virtual reality (VR) displays, augmented reality displays, holographic displays, and the like, as would be understood by one of ordinary skill in the art.

In some examples, internal bus subsystem 2704 can provide a mechanism for letting the various components and subsystems of computer system 2700 communicate with each other as intended. Although internal bus subsystem 2704 is shown schematically as a single bus, alternative embodiments of the bus subsystem can utilize multiple buses. Additionally, network interface subsystem 2712 can serve as an interface for communicating data between computer system 2700 and other computer systems or networks. Embodiments of network interface subsystem 2712 can include wired interfaces (e.g., Ethernet, CAN, RS232, RS485, etc.) or wireless interfaces (e.g., Bluetooth®, BLE, ZigBee®, Z-Wire®, Wi-Fi, cellular protocols, etc.).

In some cases, user interface input devices 2714 can include a keyboard, a presenter, a pointing device (e.g., mouse, trackball, touchpad, etc.), a touch-screen incorporated into a display, audio input devices (e.g., voice recognition systems, microphones, etc.), Human Machine Interfaces (HMI) and other types of input devices. In general, use of the term “input device” is intended to include all possible types of devices and mechanisms for inputting information into computer system 2700. Additionally, user interface output devices 2716 can include a display subsystem, a printer, or non-visual displays such as audio output devices, etc. The display subsystem can be any known type of display device. In general, use of the term “output device” is intended to include all possible types of devices and mechanisms for outputting information from computer system 2700.

Storage subsystem 2706 can include memory subsystem 2708 and file storage subsystem 2710. Memory subsystems 2708 and file storage subsystem 2710 represent non-transitory computer-readable storage media that can store program code and/or data that provide the functionality of embodiments of the present disclosure. In some embodiments, memory subsystem 2708 can include a number of memories including main random access memory (RAM) 2718 for storage of instructions and data during program execution and read-only memory (ROM) 2720 in which fixed instructions may be stored. File storage subsystem 2710 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 2700 is illustrative and not intended to limit embodiments of the present disclosure. Many other configurations having more or fewer components than system 2700 are possible. The various embodiments further can be implemented in a wide variety of operating environments, which in some cases can include one or more user computers, computing devices or processing devices, which can be used to operate any of a number of applications. User or client devices can include any of a number of general purpose personal computers, such as desktop or laptop computers running a standard or non-standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response to requests from user devices, such as by executing one or more applications that may be implemented as one or more scripts or programs written in any programming language, including but not limited to Java®, C, C# or C++, or any scripting language, such as Perl, Python or TCL, as well as combinations thereof. The server(s) may also include database servers, including without limitation those commercially available from Oracle®, Microsoft®, Sybase® and IBM®.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connections to other computing devices such as network input/output devices may be employed.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to deliver targeted content that may be of greater interest to the user in accordance with their preferences. Accordingly, use of such personal information data enables users to have greater control of the delivered content. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

The present document provides illustrations and descriptions, but is not intended to be exhaustive or to limit the scope of the invention to the precise form disclosed. Modifications and variations are possible in light of the above teachings or may be acquired from practice of various implementations of the present disclosure.

What is claimed is:

1. A method comprising:
receiving floor plan data corresponding to at least one of a location, dimensions, or orientation of one or more walls defining at least one room of a building;
receiving sensor data corresponding to detected activity within the at least one room of the building;
determining a type of the at least one room of the building based on the detected activity; and
modifying the floor plan data to include the determined type of the at least one of the one or more rooms, wherein a visual representation of the floor plan data is operable to be output on a display device.

2. The method of claim 1 further comprising:
determining an area of the at least one room of the building,
wherein determining the type of the at least one room is further based on the area of the at least one room.

3. The method of claim 2 wherein the floor plan data includes a plurality of rooms, and wherein determining the type of the at least one room is further based on the location of the one room relative to locations of the remaining plurality of rooms.

4. The method of claim 1 wherein the sensor data includes image data, and wherein the method further comprises:
tracking a movement of an object in the one or more rooms,
wherein determining the type of the at least one of the one or more rooms is further based on at least one of:
an amount of time the object has spent in the one or more rooms, the amount of time based on the tracked movement of the object; and
a traffic pattern of the object in the one or more rooms, the traffic pattern of the object based on the tracked movement of the object.

5. The method of claim 1 wherein the sensor data includes audio data, and wherein the method further comprises:
tracking a movement of an object in the one or more rooms,
wherein determining the type of the at least one of the one or more rooms is further based on at least one of:
an amount of time the object has spent in the one or more rooms, the amount of time based on the tracked movement of the object; and
a traffic pattern of the object in the one or more rooms, the traffic pattern of the object based on the tracked movement of the object.

6. The method of claim 1 wherein the sensor data includes electromagnetic interference (EMI) data, and wherein the method further comprises:
determining a type of the object based on the EMI data;
tracking a movement of an object in the one or more rooms,
wherein determining the type of the at least one of the one or more rooms is further based on at least one of:
an amount of time the object has spent in the one or more rooms, the amount of time based on the tracked movement of the object; and
a traffic pattern of the object in the one or more rooms, the traffic pattern of the object based on the tracked movement of the object.

7. The method of claim 6 wherein determining a type of the object based on the EMI data includes determining a unique digital identifier (unique ID) of the object.

8. The method of claim 1 wherein the digital floor plan data includes a location of a powered appliance within the at least one room of the building,
wherein the sensor data includes power data from the powered appliance, and
wherein determining the type of the at least one room of the building is further based on the power data of the powered appliance.

9. The method of claim 8 wherein the power data includes at least one of:
a power usage profile;
a power frequency profile;
a power factor; and
inductive or reactive loads.

10. The method of claim 1 wherein the digital floor plan data includes a location of a host unit disposed within one of the one or more walls,
wherein the sensor data includes accelerometer data from the host unit, the accelerometer data including data corresponding to vibrations within the wall that the host unit is disposed in, and
wherein the determining the type of the at least one room of the building is further based on characteristics and a location of the detected vibrations.

11. A non-transitory computer-program product tangibly embodied in a machine-readable non-transitory storage medium that includes instructions configured to cause one or more processors to perform operations including:
receiving floor plan data corresponding to at least one of a location, dimensions, or orientation of one or more walls defining at least one room of a building;
receiving sensor data corresponding to detected activity within the at least one room of the building;
determining a type of the at least one room of the building based on the detected activity; and
modifying the floor plan data to include the determined type of the at least one of the one or more rooms, wherein a visual representation of the floor plan data is operable to be output on a display device.

12. The computer program product of claim 11 wherein the instructions are further configured to cause the one or more processors to perform operations including:
determining an area of the at least one room of the building,
wherein determining the type of the at least one room is further based on the area of the at least one room.

13. The computer program product of claim 12 wherein the floor plan data includes a plurality of rooms, and wherein determining the type of the at least one room is further based on the location of the one room relative to locations of the remaining plurality of rooms.

14. The computer program product of claim 11 wherein the sensor data includes image data, and wherein the instructions are further configured to cause the one or more processors to perform operations including:
tracking a movement of an object in the one or more rooms,
wherein determining the type of the at least one of the one or more rooms is further based on at least one of:
an amount of time the object has spent in the one or more rooms, the amount of time based on the tracked movement of the object; and
a traffic pattern of the object in the one or more rooms, the traffic pattern of the object based on the tracked movement of the object.

15. The computer program product of claim 11 wherein the sensor data includes audio data, and wherein the instructions are further configured to cause the one or more processors to perform operations including:
tracking a movement of an object in the one or more rooms,
wherein determining the type of the at least one of the one or more rooms is further based on at least one of:
an amount of time the object has spent in the one or more rooms, the amount of time based on the tracked movement of the object; and
a traffic pattern of the object in the one or more rooms, the traffic pattern of the object based on the tracked movement of the object.

16. A system comprising:
one or more processors; and
one or more non-transitory, electronic storage mediums that include instructions configured to cause the one or more processors to:
receive floor plan data corresponding to at least one of a location, dimensions, or orientation of one or more walls defining at least one room of a building;
receive sensor data corresponding to detected activity within the at least one room of the building;
determine a type of the at least one room of the building based on the detected activity; and
modify the floor plan data to include the determined type of the at least one of the one or more rooms, wherein a visual representation of the floor plan data is operable to be output on a display device.

17. The system of claim 16 wherein the instructions are further configured to cause the one or more processors to:
determine an area of the at least one room of the building,
wherein determining the type of the at least one room is further based on the area of the at least one room.

18. The system of claim 17 wherein the floor plan data includes a plurality of rooms, and wherein determining the type of the at least one room is further based on the location of the one room relative to locations of the remaining plurality of rooms.

19. The system of claim 16 wherein the sensor data includes image data, and wherein the instructions are further configured to cause the one or more processors to:
track a movement of an object in the one or more rooms,
wherein determining the type of the at least one of the one or more rooms is further based on at least one of:
an amount of time the object has spent in the one or more rooms, the amount of time based on the tracked movement of the object; and
a traffic pattern of the object in the one or more rooms, the traffic pattern of the object based on the tracked movement of the object.

20. The system of claim 16 wherein the sensor data includes audio data, and wherein the instructions are further configured to cause the one or more processors to:
track a movement of an object in the one or more rooms,
wherein determining the type of the at least one of the one or more rooms is further based on at least one of:
an amount of time the object has spent in the one or more rooms, the amount of time based on the tracked movement of the object; and
a traffic pattern of the object in the one or more rooms, the traffic pattern of the object based on the tracked movement of the object.
